(19) United States
(12) Patent Application Publication
(10) Pub. No.: US 2025/0230371 A1
(43) Pub. Date: Jul. 17, 2025

(54) PETROCHEMICAL REFINING POWERED BY GEOTHERMAL ENERGY

(71) Applicant: EnhancedGEO Holdings, LLC, St. Petersburg, FL (US)

(72) Inventors: Kimberly C. Conner, Gouldsboro, ME (US); Greg Lindberg, Thonotosassa, FL (US)

(21) Appl. No.: 19/013,421

(22) Filed: Jan. 8, 2025

Related U.S. Application Data
(60) Provisional application No. 63/619,932, filed on Jan. 11, 2024.

(51) Int. Cl. C10G 55/06; F03G 4/00; F24T 50/00

(52) U.S. Cl. CPC C10G 55/06; F03G 4/00; F24T 50/00

(57) ABSTRACT

A geothermally powered petrochemical refining system includes a geothermal system with a wellbore extending from a surface into an underground magma reservoir. A geothermally powered fractional distillation system receives crude oil and produces distillates which are separated by molecular weight. The distillates may be provided to a geothermally powered cracking system that is heated by a heat transfer fluid heated by the geothermal system to crack heavy hydrocarbons into lighter ones. The distillates may be provided to a geothermally powered reforming system that is heated by a heat transfer fluid heated by the geothermal system to reform hydrocarbons into different structures.

### RELATED APPLICATIONS

The present disclosure claims priority to U.S. Provisional Patent Application Ser. No. 63/619,932, filed Jan. 11, 2024, which is incorporated herein by reference in its entirety for all purposes.

### TECHNICAL FIELD

The present disclosure relates generally to petrochemical refining powered by geothermal energy.

### BACKGROUND

Petrochemicals are produced by refinement through energy intensive processes involving heat and mechanical energy. Considerable energy is expended to supply heat and power the equipment used to perform such production. Renewable energy sources, such as solar power and wind power, can be unreliable and have relatively low power densities, such that they may be insufficient to reliably power petrochemical refining equipment. As such, production equipment typically relies on non-renewable fuels for power. There exists a need for improved petrochemical refining processes.

### SUMMARY

This disclosure recognizes the previously unidentified and unmet need for a reliable renewable energy source for petrochemical refining. This disclosure provides a solution to this unmet need in the form of a petrochemical refining system that is powered at least partially by geothermal energy. A geothermal system harnesses heat from a geothermal resource with a sufficiently high temperature that can be used to power equipment used in petrochemical refining. For example, steam may be obtained from a geothermal system and used to heat one or more reactor vessels in the petrochemical refining system. For example, heated fluid may be used to heat a desalter to remove salt from crude oil prior to refining. As another example, heated fluid from a geothermal system may be used to heat a heat exchanger to maintain appropriate temperatures for separation of hydrocarbons in a fractional distillation column. In some cases, one or more geothermally powered motors may be powered with steam from a geothermal system and used to support mechanical operations of the petrochemical refining process, such as to rotate a mixer to mix crude oil during desalting. As another example, the same or a different geothermally powered motor may power a pump that is used to move fluids between different process equipment for petrochemical refining. One or more turbines may be powered by the steam to provide electricity for any electronic components of the petrochemical refining subsystems (e.g., electronic controllers, sensors, etc.).

In some embodiments, the geothermal system that powers the petrochemical refining systems is a closed geothermal system that exchanges heat with an underground geothermal reservoir. The geothermal reservoir may be magma. For example, an underground geothermal reservoir, such as a magma reservoir, may facilitate the generation of high-temperature, high-pressure steam, while avoiding problems and limitations associated with previous geothermal technology. The geothermal systems of this disclosure generally include a wellbore that extends from a surface into an underground thermal reservoir, such as a magma. A closed heat-transfer loop is employed in which a heat transfer fluid is pumped into the wellbore, heated via contact with the underground thermal reservoir, and returned to the surface to power a petrochemical refining system located within a sufficient proximity to the wellbore.

The geothermal system of this disclosure may harness a geothermal resource with sufficiently high amounts of energy from magmatic activity such that the geothermal resource does not degrade significantly over time. This disclosure illustrates improved systems and methods for capturing energy from magma reservoirs, dikes, sills, and other magmatic formations that are significantly higher in temperature than heat sources that are accessed using previous geothermal technologies and that can contain an order of magnitude higher energy density than the geothermal fluids that power previous geothermal technologies. In some cases, the present disclosure can significantly decrease petrochemical refining costs and/or reliance on non-renewable resources for petrochemical refining subsystem operations. In some cases, the present disclosure may facilitate more efficient petrochemical refining in regions where access to reliable power is currently unavailable or transport of non-renewable fuels is challenging. The systems and methods of the present disclosure may also or alternatively aid in decreasing carbon emissions.

Certain embodiments may include none, some, or all of the above technical advantages. One or more technical advantages may be readily apparent to one skilled in the art from figures, description, and claims included herein.

### BRIEF DESCRIPTION OF THE FIGURES

For a more complete understanding of the present disclosure, reference is now made to the following description, taken in conjunction with the accompanying drawings and detailed description, in which like reference numerals represent like parts.

FIG. 1 is a diagram of underground regions near a tectonic plate boundary in the Earth.

FIG. 2 is a diagram of a conventional geothermal system.

FIG. 3 is a diagram of an example improved geothermal system of this disclosure.

FIG. 4 is a diagram of an example system in which petrochemical refining is powered by the improved geothermal system of FIG. 3.

FIG. 5 is a diagram of the example fractional distillation system of FIG. 4 for heating, desalting, and separating crude oil by hydrocarbon weight, in greater detail.

FIG. 6 is a flowchart of an example method for operating the fractional distillation system of FIG. 4.

FIG. 7 is a diagram of the example cracking system of FIG. 4 for breaking heavy hydrocarbons into lighter hydrocarbons, in greater detail.

FIG. 8 is a flowchart of an example method for operating the cracking system of FIG. 4.

FIG. 9 is a diagram of an example reforming system of FIG. 4 for converting hydrocarbons from one chemical structure to another, in greater detail.

FIG. 10 is a flowchart of an example method for operating the reforming system of FIG. 4.

FIG. 11 is a is a diagram of an example system for performing thermal processes of FIGS. 3 and 4.

FIG. 12 is a diagram of an example system for heating and cooling system components shown in FIGS. 5, 7, and 9 using heat transfer fluids and geothermal heating.

FIG. 13 is a diagram of an example temperature controller used to operate heating and cooling functions in FIG. 12.

FIG. 14 is a flowchart of an example method for operating the example temperature controller of FIG. 12.

### DETAILED DESCRIPTION

Embodiments of the present disclosure and its advantages will become apparent from the following detailed description when considered in conjunction with the accompanying figures. In the figures, each identical, or substantially similar component that is illustrated in various figures is represented by a single numeral or notation. For purposes of clarity, not every component is labeled in every figure, nor is every component of each embodiment shown where illustration is not necessary to allow those of ordinary skill in the art to understand the disclosure.

As used herein, “magma” refers to extremely hot liquid and semi-liquid rock under the Earth's surface. Magma is formed from molten or semi-molten rock mixture found typically between 1 km to 10 km under the surface of the Earth. As used herein, “borehole” refers to a hole that is drilled to aid in the exploration and recovery of natural resources, including oil, gas, water, or heat from below the surface of the Earth. As used herein, a “wellbore” refers to a borehole either alone or in combination with one or more other components disposed within or in connection with the borehole in order to perform exploration and/or recovery processes. In some cases, the terms “wellbore” and “borehole” may be used interchangeably. As used herein, “heat transfer fluid” refers to a fluid, e.g., a gas or liquid, that takes part in heat transfer by serving as an intermediary in cooling on one side of a process, transporting and storing thermal energy, and heating on another side of a process. Heat transfer fluids are used in processes requiring heating or cooling.

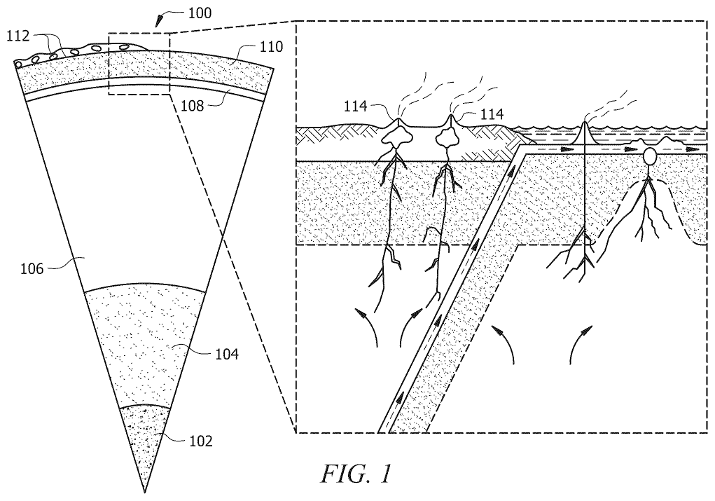

FIG. 1 is a partial cross-sectional diagram of the Earth depicting underground formations that can be tapped by geothermal systems of this disclosure (e.g., for generating geothermal power). The Earth is composed of an inner core 102, outer core 104, lower mantle 106, transition zone 108, upper mantle 110, and crust 112. There are places on the Earth where magma reaches the surface of the crust 112 forming volcanoes 114. However, in most cases, magma approaches only within a few miles or less from the surface. This magma can heat ground water to temperatures sufficient for certain geothermal power production. However, for other applications, such as geothermal energy production, more direct heat transfer with the magma is desirable.

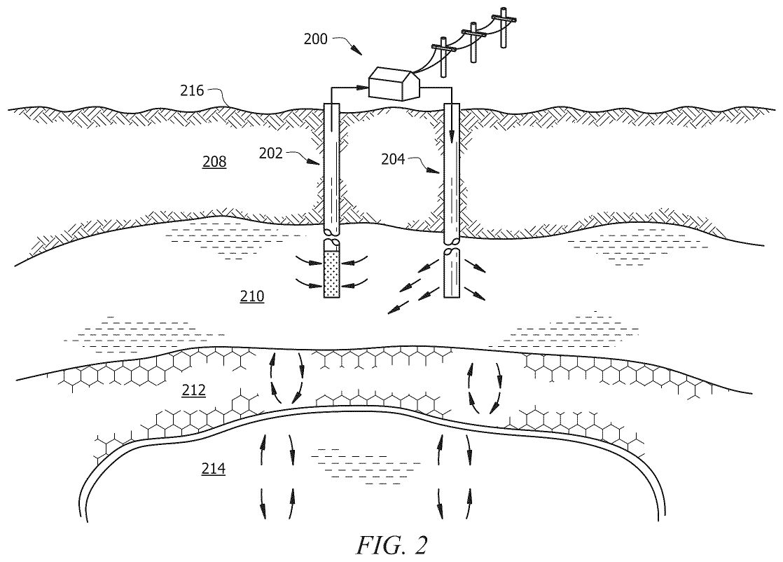

FIG. 2 illustrates a conventional geothermal system 200 that harnesses energy from heated ground water for power generation. The conventional geothermal system 200 is a “flash-plant” that generates power from a high-temperature, high-pressure geothermal water extracted from a production well 202. The production well 202 is drilled through rock layer 208 and into the geothermal fluid layer 210 that serves as the source of geothermal water. The geothermal water is heated indirectly via heat transfer with intermediate layer 212, which is in turn heated by magma reservoir 214. Convective heat transfer (illustrated by the arrows indicating that hotter fluids rise to the upper portions of their respective layers before cooling and sinking, then rising again) may facilitate heat transfer between these layers. Geothermal water from the geothermal fluid layer 210 flows to the surface 216 and is used for geothermal power generation. The geothermal water (and possibly additional water or other fluids) is then injected back into the geothermal fluid layer 210 via an injection well 204.

The configuration of conventional geothermal system 200 of FIG. 2 suffers from drawbacks and disadvantages, as recognized by this disclosure. For example, the system 200 may not achieve sufficiently high temperatures to facilitate efficient petrochemical processing. As another example, because geothermal water is a multicomponent mixture (i.e., not pure water), the geothermal water flashes at various points along its path up to the surface 216, creating water hammer, which results in a large amount of noise and potential damage to system components. The geothermal water is also prone to causing scaling and corrosion of system components. Chemicals may be added to partially mitigate these issues, but this may result in considerable increases in operational costs and increased environmental impacts, since these chemicals are generally introduced into the environment via injection well 204.

### Example Improved Geothermal System

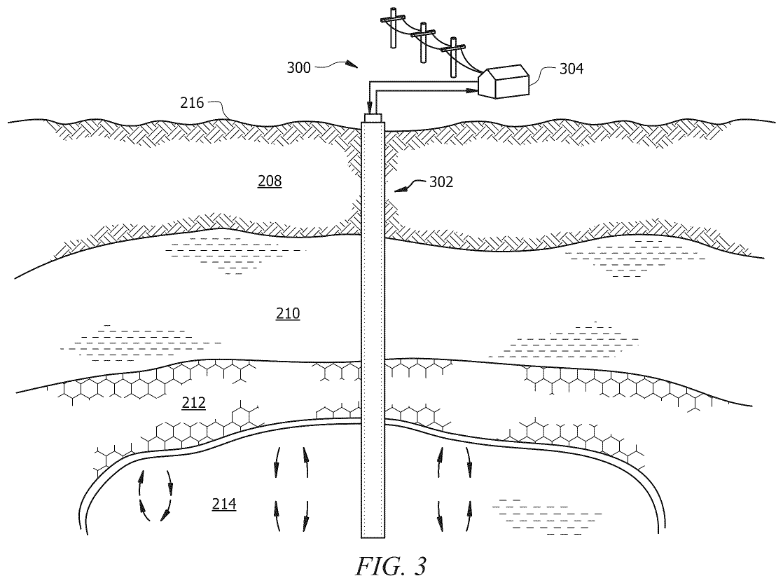

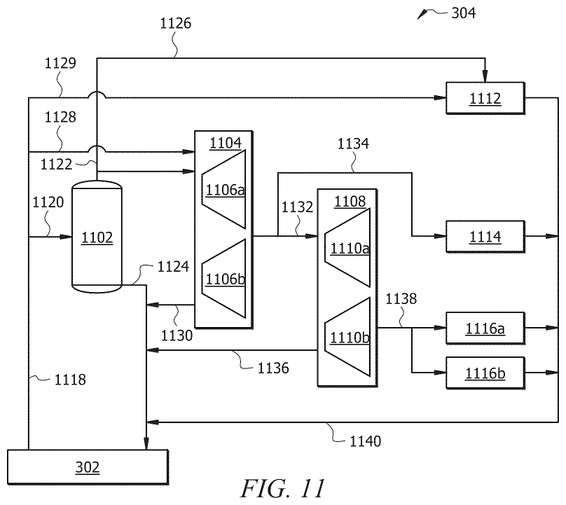

FIG. 3 illustrates an example magma-based geothermal system 300 of this disclosure. The magma-based geothermal system 300 includes a wellbore 302 that extends from the surface 216 at least partially into the magma reservoir 214. The magma-based geothermal system 300 is a closed system in which a heat transfer fluid is provided down the wellbore 302 to be heated and returned to a thermal process system 304 (e.g., for power generation and/or any other thermal processes of interest). As such, geothermal water is not extracted from the Earth, resulting in significantly reduced risks associated with the conventional geothermal system 200 of FIG. 2, as described further below. Heated heat transfer fluid is provided to the thermal process system 304. The thermal process system 304 is generally any system that uses the heat transfer fluid to drive a process of interest. For example, the thermal process system 304 may include an electricity generation system and/or support thermal processes requiring higher temperatures/pressures than could be reliably or efficiently obtained using previous geothermal technology, such as the conventional geothermal system 200 of FIG. 2. Further details of components of an example thermal process system 304 are provided with respect to FIG. 11 below.

The magma-based geothermal system 300 provides technical advantages over previous geothermal systems, such as the conventional geothermal system 200 of FIG. 2. The magma-based geothermal system 300 can achieve higher temperatures and pressures for increased energy generation (and/or for more effectively driving other thermal processes). For example, because of the high energy density of magma in magma reservoir 214 (e.g., compared to that of geothermal water of the geothermal fluid layer 210), wellbore 302 can generally create the power of many wells of the conventional geothermal system 200 of FIG. 2. Furthermore, the magma-based geothermal system 300 has little or no risk of thermal shock-induced earthquakes, which might be attributed to the injection of cooler water into a hot geothermal zone, as is performed using the conventional geothermal system 200 of FIG. 2. The heat transfer fluid is generally not substantially released into the geothermal zone, resulting in a decreased environmental impact and decreased use of costly materials (e.g., chemical additives that are used and introduced to the environment in great quantities during some conventional geothermal operations). The magma-based geothermal system 300 may also have a simplified design and operation compared to those of previous systems. For instance, fewer components and reduced complexity may be needed at the thermal process system 304 because only clean heat transfer fluid (e.g., steam) reaches the surface 216. There may be no need or a reduced need to separate out solids or other impurities that are common to geothermal water. The example magma-based geothermal system 300 may include further components not illustrated in FIG. 3.

Further details and examples of different configurations of geothermal systems and methods of their preparation and operation are described in U.S. patent application Ser. No. 18/099,499, filed Jan. 20, 2023, and titled “Geothermal Power from Superhot Geothermal Fluid and Magma Reservoirs”; U.S. patent application Ser. No. 18/099,509, filed Jan. 20, 2023, and titled “Geothermal Power from Superhot Geothermal Fluid and Magma Reservoirs”; U.S. patent application Ser. No. 18/099,514, filed Jan. 20, 2023, and titled “Geothermal Power from Superhot Geothermal Fluid and Magma Reservoirs”; U.S. patent application Ser. No. 18/099,518, filed Jan. 20, 2023, and titled “Geothermal Power from Superhot Geothermal Fluid and Magma Reservoirs”; U.S. patent application Ser. No. 18/105,674, filed Feb. 3, 2023, and titled “Wellbore for Extracting Heat from Magma Chambers”; U.S. patent application Ser. No. 18/116,693, filed Mar. 2, 2023, and titled “Geothermal systems and methods with an underground magma chamber”; U.S. patent application Ser. No. 18/116,697, filed Mar. 2, 2023, and titled “Method and system for preparing a geothermal system with a magma chamber”; and U.S. Provisional Patent Application No. 63/444,703, filed Feb. 10, 2023, and titled “Geothermal systems and methods using energy from underground magma reservoirs”, the entirety of each of which is hereby incorporated by reference.

### Geothermally Powered Petrochemical Production

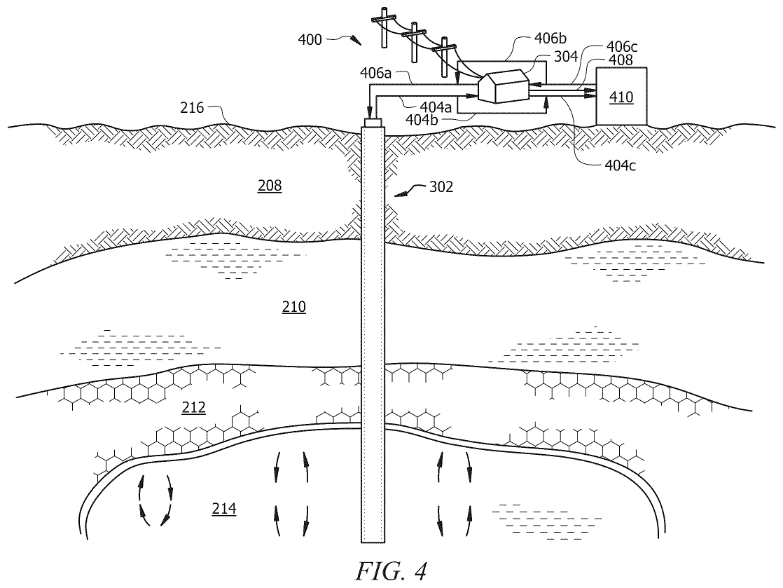

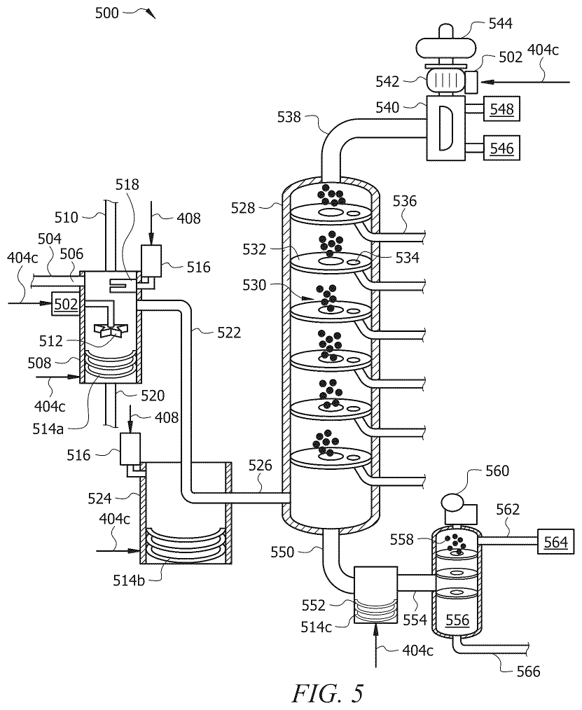

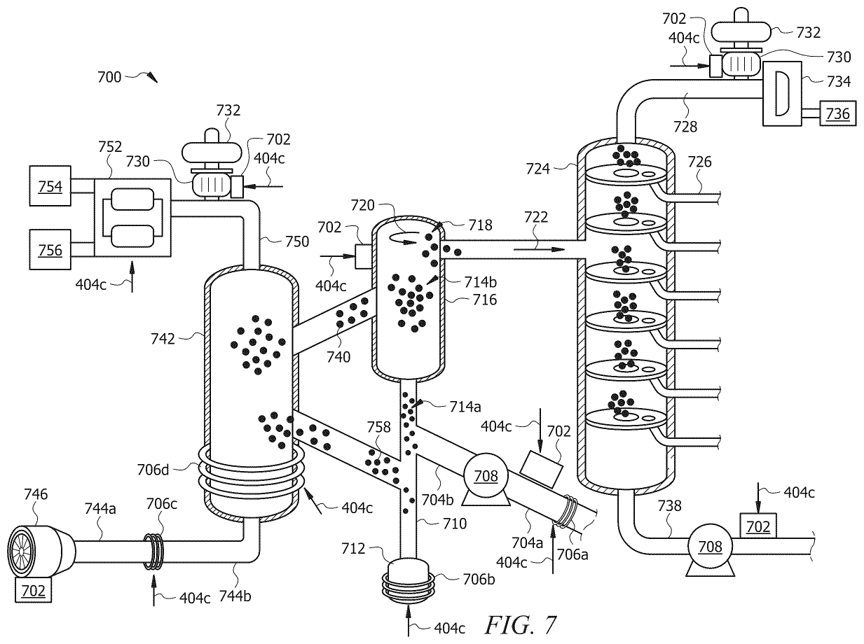

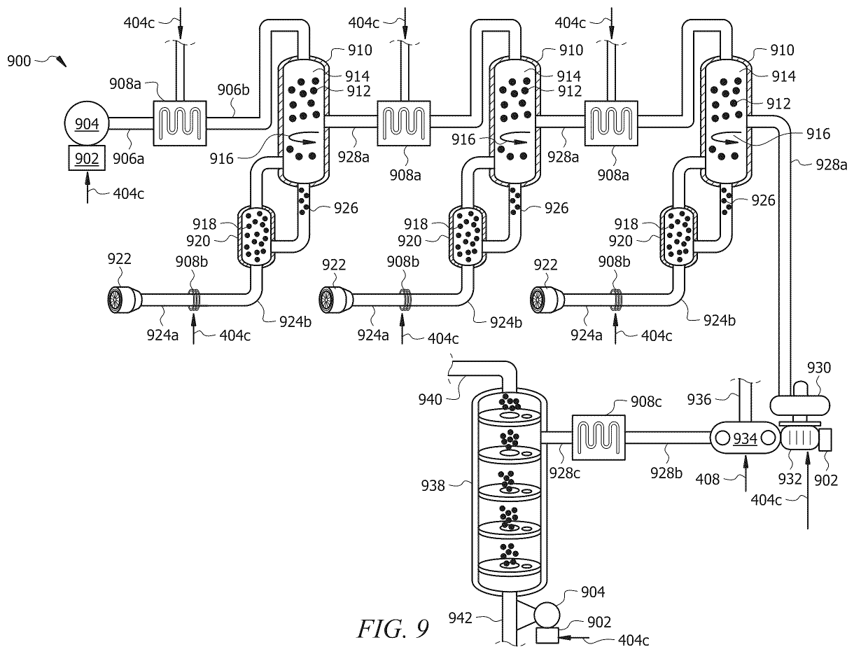

FIG. 4 illustrates an example combined geothermal and petrochemical refining system 400 of this disclosure. The combined geothermal and petrochemical refining system 400 includes all or a portion of the components of the magma-based geothermal system 300 described above with respect to FIG. 3 as well as geothermally powered petrochemical refining system 410. The geothermally powered petrochemical refining system 410 may include a geothermally powered fractional distillation system (e.g., system 500 of FIG. 5) for removing impurities from crude oil, heating the crude oil, and separating the crude oil into fractions of hydrocarbons by molecular weight. The geothermally powered petrochemical refining system 410 may include a geothermally powered cracking system (e.g., system 700 of FIG. 7) for cracking heavy hydrocarbons into lighter ones, and/or a geothermally powered reforming system (e.g., system 900 of FIG. 9) for changing the structure of hydrocarbons using geothermal heat. The combined geothermal and petrochemical refining system 400 may include all or a portion of the thermal process system 304.

In operation, heat transfer fluid is injected into the wellbore 302, which extends from the surface 216 into the magma reservoir 214 underground. The heated heat transfer fluid can be conveyed to the thermal process system 304 as heat transfer fluid 404a that can be used to drive processes, such as the generation of electricity 408 by the first turbine set 1104 and the second turbine set 1108 in FIG. 11. Heat transfer fluid 404a may be referred to in the alternative as a stream of heat transfer fluid 404a. Heat transfer fluid 404c, which can be formed from any remaining amount of heat transfer fluid 404a (e.g., steam) exiting from the thermal process system 304 and/or the wellbore bypass stream, i.e., heat transfer fluid 404b, is provided to the geothermally powered petrochemical refining system 410. The electricity 408 may be used in addition to or in place of heat transfer fluid 404c for powering electrical and mechanical processes in the geothermally powered petrochemical refining system 410.

As described in greater detail below with respect to FIGS. 5, 7, and 9 the geothermally powered petrochemical refining system 410 can use the heat transfer fluid 404c to drive fractional distillation, cracking, and/or reforming processes to produce petrochemicals. For example, a geothermally powered fractional distillation system may include a motor that aids in moving a mixer in a desalter and is powered by heat transfer fluid 404c (e.g., steam) heated in the wellbore 302 (see FIG. 5 and corresponding descriptions below). As another example, a geothermally powered cracking system may include a fluid pump with a motor that is powered at least in part by the heat transfer fluid 404c (e.g., steam) heated in the wellbore 302 (see FIG. 7 and corresponding descriptions below). As another example, a geothermally powered reforming system may include a motor that aids in moving a cyclone in a reactor and is powered by heat transfer fluid 404c (e.g., steam) heated in the wellbore 302 (see FIG. 9 and corresponding descriptions below).

In some cases, cooling may be desirable for certain processes. An absorption chiller may use heated fluid from the geothermal system to provide such cooling. In some cases, temperature adjustments or control may be achieved using heated fluid from the geothermal system and/or cooling from a geothermally powered absorption chiller. In this way, for example, processing offgas during cracking can be improved by operating at a temperature that facilitates more effective separation of hydrogen from other petrochemical streams (see FIG. 7 and corresponding descriptions below). More generally, reaction conditions can be adjusted to improve refining of petrochemicals using hot or cold fluid obtained via geothermal energy with limited or no use of other energy inputs, and by using a temperature control system to maintain the temperature between a desired minimum and maximum values to improve product yield and to reduce the generation of unwanted byproducts. More detailed examples of operations of a geothermally powered fractional distillation system, a geothermally powered cracking system, and a geothermally powered reforming system are provided below with respect to FIGS. 5, 7, and 9, respectively.

Heat transfer fluid (e.g., condensed steam) that is cooled and/or or decreased in pressure after powering the geothermally powered petrochemical refining system 410 may be returned to the wellbore 302 as heat transfer fluid 406a. For instance, as shown in the example of FIG. 4, a stream of return heat transfer fluid 406c may be provided back to the thermal process system 304, used to drive one or more reactions or processes, and then expelled as heat transfer fluid 406a for return to the wellbore 302. The heat transfer fluid 406a can also include a bypass stream of heat transfer fluid 406b, which can be formed from heat transfer fluid 406c, in whole or in part. Restated, thermally processed return stream of heat transfer fluid 406a includes heat transfer fluid (e.g., condensed steam) from the thermal process system 304 and/or the bypass stream of heat transfer fluid 406b. Thermally processed return stream of heat transfer fluid 406a that is sent back to the wellbore 302 may be water (or another heat transfer fluid), while the stream of heat transfer fluid 404a received from the wellbore 302 is steam (or another heat transfer fluid at an elevated temperature and/or pressure). While the example of FIG. 4 includes the thermal process system 304 of FIG. 3, in some cases, the combined geothermal and petrochemical refining system 400 may exclude all or a portion of the thermal process system 304. For example, the wellbore stream of heat transfer fluid 404a from the wellbore 302 may be provided directly to the geothermally powered petrochemical refining system 410 (see wellbore bypass stream of heat transfer fluid 404b described above).

Heat transfer fluid in streams 404a-c and 406a-c may be any appropriate fluid for absorbing heat within the wellbore 302 and driving operations of the geothermally powered petrochemical refining system 410 and, optionally the thermal process system 304. For example, the heat transfer fluid may include water, a brine solution, one or more refrigerants, a thermal oil (e.g., a natural or synthetic oil), a silicon-based fluid, a molten salt, a molten metal, or a nanofluid (e.g., a carrier fluid containing nanoparticles). A molten salt is a salt that is a liquid at the high operating temperatures experienced in the wellbore 302 (e.g., at temperatures between 1,600 and 2,300° F.). In some cases, an ionic liquid may be used as the heat transfer fluid. An ionic liquid is a salt that remains a liquid at more modest temperatures (e.g., at or near room temperature). In some cases, a nanofluid may be used as the heat transfer fluid. The nanofluid may be a molten salt or ionic liquid with nanoparticles, such as graphene nanoparticles, dispersed in the fluid. Nanoparticles have at least one dimension of 100 nanometers (nm) or less. The nanoparticles increase the thermal conductivity of the molten salt or ionic liquid carrier fluid. This disclosure recognizes that molten salts, ionic liquids, and nanofluids can provide improved performance as heat transfer fluids in the wellbore 302. For example, molten salts and/or ionic liquids may be stable at the high temperatures that can be reached in the wellbore 302. The high temperatures that can be achieved by these materials not only facilitate increased energy extraction but also can drive thermal processes that were previously inaccessible using previous geothermal technology. The heat transfer fluid may be selected at least in part to limit the extent of corrosion of surfaces of the combined geothermal and petrochemical refining system 400. As an example, the heat transfer fluid may be water. The water is supplied to the wellbore 302 as stream of heat transfer fluid 406a in the liquid phase and is transformed into steam within the wellbore 302. The steam is received as stream of heat transfer fluid 404a and used use to drive the geothermally powered petrochemical refining system 410.

### Example Geothermally Powered Fractional Distillation

FIG. 5 shows an example of a geothermally powered fractional distillation system 500 that can be used as part of the system 410 in FIG. 4. The configuration of FIG. 5 is provided as an example only. The geothermally powered fractional distillation system 500 may include more or fewer components, and the components may be arranged in different configurations to produce distillate streams 536, gas 546, gasoline 548, and gas oil streams 562. The geothermally powered fractional distillation system 500 may produce more or fewer petrochemical products. The example geothermally powered fractional distillation system 500 includes a desalter 508, a crude boiler 524, an atmospheric distillation column 528, a residue boiler 552, a vacuum distillation column 556, and a gas separator 540. These main components and other components may be powered at least partially by geothermal energy from the heat transfer fluid 404c (e.g., steam). This heat transfer fluid 404c may be used directly to heat, to a predefined temperature range, components in geothermally powered fractional distillation system 500 or to heat a secondary heat transfer fluid. The secondary heat transfer fluid may be any similarly suitable fluid as chosen in the primary fluid, the heat transfer fluid 404c. The heat transfer fluid 404c or secondary heat transfer fluid may be used to heat components or may be converted to mechanical or electrical energy to perform operations in the geothermally powered fractional distillation system 500.

During operation of the geothermally powered fractional distillation system 500, a crude oil 506 is processed for removal of salts, heated, and separated into distillates by molecular weight. The crude oil input 504 receives the crude oil 506. The crude oil 506 is extracted from the Earth and may be either directly received by the crude oil input 504 upon extraction or may be transported over distance before feeding into the crude oil input 504. The crude oil 506 may contain salts (e.g., sodium chloride) and other impurities (e.g., sand, drilling mud) that require removal before processing. The presence of salts may cause corrosion or plugging in the system components (e.g., fractionator, pipeline) and interfere with chemical reactions throughout the refining pipeline. A geothermally powered motor 502 coupled to a mixer 512 may power the mixer 512. The geothermally powered motor 502 can be coupled to system components, such as the mixer 512, using conventional means, e.g., mechanical, electrical, pneumatic, etc., which are omitted for the sake of simplicity. The mixer 512 is used to enhance agitation of the crude oil 506 and water 510. The mixer 512 is any machine capable of agitating the crude oil 506 and the water 510 contained by the desalter 508 to maximize the interfacial surface area for optimal contact between oil and water. In the example of FIG. 5, a geothermally powered motor 502 rotates the mixer 512. The mixer 512 may include beaters, paddles, propellers, hydrofoils, mixing valves, static mixers, or turbines, as examples. The geothermally powered motor 502 may be powered directly by the heat transfer fluid 404c that is heated by the magma reservoir 214 or using electricity 408. An example of geothermally powered motor is described in U.S. Provisional Patent Application No. 63/448,929, filed Feb. 28, 2023, and titled “Drilling Equipment Powered by Geothermal Energy,” the entirety of which is incorporated herein by reference.

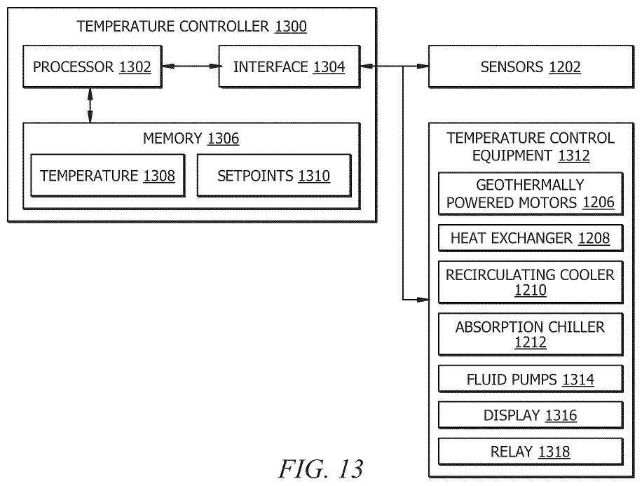

During mixing of the crude oil 506 and the water 510, heating is applied. To achieve this, the desalter 508 may be heated or cooled accordingly, as needed, to maintain the temperature in the desalter 508 at a target temperature or within a predefined temperature range. A temperature setpoint is maintained by a temperature control system (e.g., temperature controller 1300 of FIG. 13) positioned within or proximate to the desalter 508. The desalter 508 can be heated (e.g., to about 120-150° C.) by a heat exchanger 514a, which can be heated by heat transfer fluid 404c. The heat exchanger 514a is depicted as disposed proximal to the desalter 508 in FIG. 5 to circulate the heated heat transfer fluid to provide heat to the walls of the desalter 508 to indirectly heat the crude oil 506 and the water 510, but in other embodiments the heat exchanger 514a can be positioned within the desalter 508 which can then directly heat the crude oil 506 and the water 510. Heat exchange between the heat exchanger 514a and the crude oil 506 and the water 510 may maintain a predefined temperature range for the desalting. Examples of the heat exchanger 514a include shell-and-tube or tube-in-tube type heat exchangers.

During mixing and heating of the crude oil 506 and water 510, salts are removed from the crude oil 506 by forming salt water 520. This process of desalting may occur in one or more steps. In the example FIG. 5, desalting is shown in one step. In addition to water 510, emulsion-breaking chemicals may be added to the crude oil 506. Electricity 408 is supplied to a power unit 516 which controls the electricity 408 (e.g., the current of voltage) provided to electrodes 518. The power unit 516 can be controlled by the controller 1300 described in greater detail below with respect to FIG. 13. The electrodes 518 produce a high voltage electrostatic field within the desalter 508 to break the emulsion. The mixture of oil and water is homogeneously emulsified then separated into two phases by electrostatic coalescence induced by a polarization effect driven by the electrodes 518. The polarization of water droplets pulls them out from an oil-water emulsion phase and as salt is dissolved in these water droplets it also gets separated to from salt water 520. The salt water 520 containing extracted salts and other impurities is removed from the bottom of the desalter 508 after settling. A desalted crude oil 522 is the product.

High voltage field applications require a high energy demand. This disclosure provides a solution to this problem by facilitating the operation of the power unit 516 using geothermal energy. For example, electricity 408 derived from the conversion of heat in the heat transfer fluid 404c by turbines (e.g., the first turbine set 1104, the second turbine set 1108 of FIG. 11) may be provided to the electrodes 518, while the crude oil 506 and water 510 are heated by heat transfer fluid 404c to help improve electrostatic coalescence.

The desalted crude oil 522 is heated in a crude boiler 524 to produce heated crude oil 526 before being fractionally distilled. The crude boiler 524 may be heated as needed to maintain the temperature in the crude boiler 524 at a target temperature or within a predefined temperature range. A temperature setpoint value or range may be maintained by a temperature control system (e.g., temperature controller 1300 of FIG. 13) positioned within or proximate to the crude boiler 524. The crude boiler 524 can be heated (e.g., to about 500° C.) by a heat exchanger 514b, which can be heated by heat transfer fluid 404c. The heat exchanger 514b is depicted as disposed proximal to the crude boiler 524 in FIG. 5 to circulate the heated heat transfer fluid to provide heat to the walls of the crude boiler 524 to indirectly heat the desalted crude oil 522, but in other embodiments the heat exchanger 514b can be positioned within the crude boiler 524 which can then directly heat the desalted crude oil 522. Heat exchange between the heat exchanger 514b and the desalted crude oil 522 can maintain a predefined temperature range for heating the desalted crude oil 522. Examples of the heat exchanger 514b include shell-and-tube or tube-in-tube type heat exchangers.

The heated crude oil 526 is fed to an atmospheric distillation column 528 where it is fractionally distilled (i.e., separated into fractions of hydrocarbons by their molecular weight). Pressure may be maintained near atmospheric pressure at a predefined pressure range (e.g., 1.2 to 1.5 atm) within the atmospheric distillation column 528. The atmospheric distillation column 528 may be any vessel that facilitates separation of vapor and condensed phases. Higher molecular weight hydrocarbons have higher boiling points and are separated at the hotter bottom side of the column 528. Lighter molecular weight hydrocarbons have lower boiling points and remain in a vapor phase, moving upwards through trays 532 in the column 528 as vaporized distillates 530 and condensing at their respective boiling points where they are separated out as condensed distillates 534. The trays 532 are any barrier capable of permitting at least a portion of the vaporized distillates 530 to move toward cooler regions of the atmospheric distillation column 528 and at least a portion of the condensed distillates 534 to move toward warmer regions of the atmospheric distillation column 528.

In the example of FIG. 5, the trays 532 are plates with openings that permit passage of the vaporized distillates 530 upward as a vapor phase and surfaces that permit collection of the condensed distillates 534. Example trays include movable or floating valves, fixed valves, sieves, and bubble caps. The atmospheric distillation column 528 is depicted as utilizing trays 532 in FIG. 5 to separate the vaporized distillates 530 and the condensed distillates 534, but in other embodiments the atmospheric distillation column 528 may utilize a packed tower configuration in which, instead of having trays, the column is packed with beds of metal rings. The condensed distillates 534 are the product of the column 528. The condensed distillates 534 are drawn off from the atmospheric distillation column 528 as distillate streams 536 to be processed and stored. Example distillate streams 536 include diesel, gasoline, naptha, kerosene, diesel, lubricants, fuel oil, and bitumen, which condense at a range of temperatures (e.g., around 25 to 400° C.).

In addition to obtaining the condensed distillates 534, the atmospheric distillation column 528 may also separate gases, such as overhead light hydrocarbons 538 (around temperatures less than 25° C.), and an atmospheric residue 550 (above 350° C.). The overhead light hydrocarbons 538 may be cooled by an absorption chiller 542. The absorption chiller 542 generates a cooling fluid using the heat transfer fluid 404c and a condenser 544. The overhead light hydrocarbons 538 are separated into gas 546 and gasoline 548 by a gas separator 540. The gas 546 and gasoline 548 are stored and/or further processed for final production.

The atmospheric residue 550 is heated by a residue boiler 552. The residue boiler 552 can be heated (e.g., to 500° C.) by a heat exchanger 514c, which can be heated by heat transfer fluid 404c. The heat exchanger 514c is depicted as disposed proximal to the residue boiler 552 in FIG. 5 to circulate the heated heat transfer fluid to provide heat to the walls of the residue boiler 552 to indirectly heat the atmospheric residue 550, but in other embodiments the heat exchanger 514c can be positioned within the residue boiler 552, which can then directly heat the atmospheric residue 550 to produce a preheated residue 554. Heat exchange between the heat exchanger 514c and the atmospheric residue 550 can maintain a predefined temperature range for heating the atmospheric residue 550. Examples of the heat exchanger 514c include shell-and-tube or tube-in-tube type heat exchangers.

The preheated residue 554 is fed to a vacuum distillation column 556 where it is fractionally distilled (i.e., separated into fractions of hydrocarbons by their molecular weight) into gas oils 558. Pressure is maintained at a pressure less than atmospheric pressure (e.g., from 0.01 to 0.05 atm) within the vacuum distillation column 556 by a vacuum system 560. The vacuum distillation column 556 may be any vessel that facilitates separation of vapor and condensed phases at high temperatures and low pressure such that cracking is decreased. Higher molecular weight hydrocarbons have higher boiling points and are separated at the hotter bottom side of the column 556 (around 500° C.). Lighter molecular weight hydrocarbons have lower boiling points and remain in a vapor phase, moving upwards in a vapor phase as gas oils 558, and condensing at their respective boiling points where they are separated out as gas oil streams 562. Trays may be used (e.g., the same or similarly to as described above for the atmospheric distillation column 528) to permit at least a portion of the gas oils 558 to move toward cooler regions (around 350° C.) of the vacuum distillation column 556 and to direct at least a portion of the gas oil streams 562 to be drawn off from the vacuum distillation column 556 to be processed and stored in an oil tank 564. A vacuum residue 566 remains at the hotter bottom side of the vacuum distillation column 556 as a waste byproduct.

### Example Method of Geothermally Powered Fractional Distillation

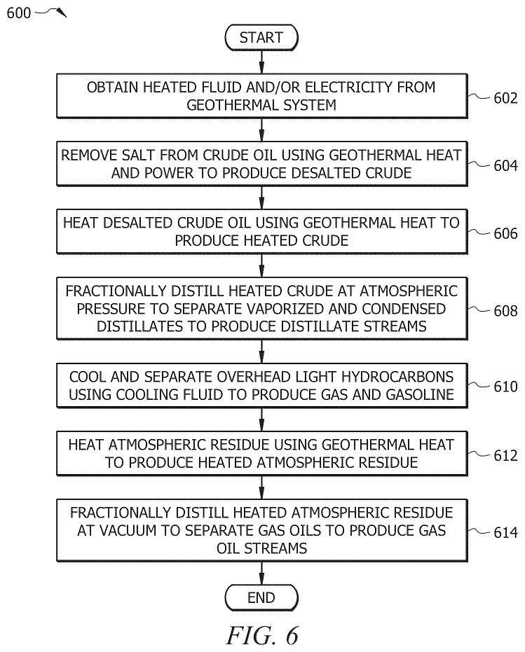

FIG. 6 shows an example method 600 of operating the geothermally powered fractional distillation system 500 of FIG. 5. The method 600 may begin at step 602. At step 602, the heat transfer fluid 404c and/or electricity 408 are received from the geothermal system 300, as described above with respect to FIGS. 1-4. At step 604, crude oil 506 is heated and/or mixed using a geothermally powered motor 502 and electrostatically treated to remove salts using geothermally derived electricity 408 to produce a desalted crude oil 522. The electrical current used for electrostatic treatment in step 604 may be provided by electricity 408 from geothermally powered turbines (e.g., the first turbine set 1104, the second turbine set 1108 of FIG. 11) configured to use the heat transfer fluid 404c heated by the geothermal system 300. At step 606, the desalted crude oil 522 is heated to produce heated crude oil 526. At step 608, the heated crude oil 526 is fractionally distilled near atmospheric pressure to separate vaporized distillates 530 and condensed distillates 534 to produce distillate streams 536. At step 610, gases (e.g., overhead light hydrocarbons 538) are cooled using a geothermally derived cooling fluid and separated to produce gas 546 and gasoline 548 (e.g., using absorption chiller 542 of FIG. 5. At step 612, an atmospheric residue 550 is heated by the heat transfer fluid 404c to produce heated atmospheric residue 554. At step 614, the heated atmospheric residue 554 is fractionally distilled under vacuum to separate gas oils 558 and to produce gas oil streams 562.

Modifications, omissions, or additions may be made to method 600 depicted in FIG. 6. Method 600 may include more, fewer, or other steps. For example, at least certain steps may be performed in parallel or in any suitable order. While at times discussed as geothermally powered fractional distillation system 500 performing steps, any suitable component of the geothermally powered fractional distillation system 500 or other components of a geothermal system may perform or may be used to perform one or more steps of the method 600.

### Example Geothermally Powered Cracking

FIG. 7 shows an example of a geothermally powered cracking system 700 that can be used as the system 410 of FIG. 4. The configuration of FIG. 7 is provided as an example only. The geothermally powered cracking system 700 may include more or fewer components, and the components may be arranged in different configurations in order to produce cracked hydrocarbon fractions 726. The example geothermally powered cracking system 700 includes a riser 710, a reactor 716, a fractionator 724, an offgas separator 734, a regenerator 742, and a flue gas separator 752. These main components and other components may be powered at least partially by geothermal energy from the heat transfer fluid 404c (e.g., steam). This heat transfer fluid 404c may be used directly to heat components in the geothermally powered cracking system 700 or to heat a secondary heat transfer fluid. The secondary heat transfer fluid may be any similarly suitable fluid as chosen in the primary fluid, the heat transfer fluid 404c. The heat transfer fluid 404c or secondary heat transfer fluid may be used to heat components to a predefined temperature range or may be converted to mechanical or electrical energy to perform operations in the geothermally powered cracking system 700. The geothermally powered cracking system 700 cracks (i.e., breaks down) larger hydrocarbons into smaller hydrocarbons. Catalytic cracking produces higher octane fuel, which is sometimes desired for modern industrial applications. The example cracking system 700 of FIG. 7 employs catalytic cracking. However, alternative cracking mechanisms, such thermal cracking, could be utilized by the geothermally powered cracking system 700.

The example geothermally powered cracking system 700 is depicted as a fluid catalytic cracking (FCC) system which utilizes a continuous flow feedstock with fluidized-bed catalysts. In other embodiments, the geothermally powered cracking system 700 can be a fixed-bed system, a moving bed system, or a batch reactor. FCC processes may have reactors in a side-by-side or stacked configuration. The geothermally powered cracking system 700 of FIG. 7 has a side-by-side configuration. However, this disclosure contemplates the geothermally powered cracking system 700 having any reactor configuration. Hydrocracking may be performed along with or in addition to catalytic cracking.

During operation of the geothermally powered cracking system 700, a feedstock 704a (e.g., crude oil) is heated (e.g., to around 300 to 430° C.) by a heat exchanger 706a, which can be heated by heat transfer fluid 404c, to produce a heated feedstock 704b. The heat exchanger 706a is depicted as disposed in a position to circulate the heated heat transfer fluid to heat the feedstock 704a prior to the feedstock 704a being moved by a pump 708 in FIG. 7, but in other embodiments the heat exchanger 706a can be positioned to heat the feedstock 704a after the feedstock 704a is moved by the pump 708. Examples of the heat exchanger 706a include shell-and-tube or tube-in-tube type heat exchangers. An example feedstock 704a may be a crude oil previously processed by the fractional distillation system 500 and/or a clarified slurry oil. The heated feedstock 704b (e.g., heated crude oil feedstock) is moved to the riser 710 using the geothermally powered pump 708. In the example of FIG. 7, a geothermally powered motor 702 coupled to the geothermally powered pump 708 may power the geothermally powered pump 708. The geothermally powered motor 702 can be coupled to the geothermally powered pump 708 using conventional means, e.g., mechanical, electrical, pneumatic, etc., which are omitted for the sake of simplicity. The geothermally powered pump 708 is any machine capable of moving the heated feedstock 704b in the riser to fluidize a catalyst 714a to facilitate a catalytic reaction (“cracking”). In the example of FIG. 7, the geothermally powered pump 708 may include injectors, nozzles, jets, and/or atomizers, as examples. The geothermally powered motor 702 may be powered directly by the heat transfer fluid 404c that is heated by the magma reservoir 214 or using electricity 408. The geothermally powered motor 702 may be the same type of motor as motor 502 of FIG. 5, described above.

During catalytic cracking, the catalyst 714a is fed to the riser 710 where it reacts with the heated feedstock 704b. The riser 710 is any tubular vessel that combines the catalyst 714a and the heated feedstock 704b to facilitate a catalytic reaction to produce shorter chain hydrocarbons. A steam generator 712 may be used to heat the catalyst 714a and the heated feedstock 704b by supplying steam produced by heating water by a heat exchanger 706b, which can be heated by heat transfer fluid 404c. The catalyst 714a is heated and mixed to form a fluidized bed of hot catalyst particles and is brought into contact with the heated feedstock 704b. The catalyst 714a evaporates the heated feedstock 704b upon contact in the riser 710, and the cracking starts as vaporized product forms on the catalyst 714a to produce a reacted catalyst with adsorbed product vapors 714b. The reacted catalyst with adsorbed product vapors 714b moves upward toward the reactor 716. An example catalyst 714a may include a zeolite, active matrix, filler, and/or binder. The catalyst 714a may be a fine powder with an average particle size of 60-75 μm. Hydrocarbon molecules are broken up in the riser 710 to produce mixtures of smaller hydrocarbons, some of which have carbon-carbon double bonds. An example reaction occurring in the riser 710 involving the hydrocarbon C₁₅H₃₂ might be: C₁₅H₃₂→2C₂H₄+C₃H₆+C₈H₁₈.

The reacted catalyst with adsorbed product vapors 714b is handled by the reactor 716 to cause a desorption reaction. The reactor 716 is a vessel that receives the reacted catalyst with adsorbed product vapors 714b that was produced by the riser 710 and separates them to produce a coked catalyst 740 and desorbed product vapors 718. The temperature of the coked catalyst 740 decreases as the heated feedstock 704b becomes vaporized, and endothermic cracking reactions proceed during the upward movement from the riser 710 to the reactor 716. The cracking reactions may initiate on the active sites of the catalyst surfaces with the formation of carbocations, and subsequent ionic chain reactions may produce branched alkanes and aromatic compounds to constitute the products feed 722 that is sent to the fractionator 724. Example hydrocarbons are high-octane gasoline, light olefins, cycle oils, and slurry oil. Cracking reactions may also deposit a significant amount of coke on the catalyst 714a, leading to deactivation of the catalyst 714a and formation of the coked catalyst 740. The adsorbed hydrocarbons are removed by steam stripping and use of a cyclone 720. The coked catalyst 740 is then sent to the regenerator 742 to remove (e.g., burn off) the coke with heated air 744b, which, may be geothermally heated as described in below. The cyclone 720 is used by the reactor 716 to separate the product vapors from the particles of the reacted catalyst with adsorbed product vapors 714b to produce desorbed product vapors 718. Separation by the cyclone 720 may be performed through vortex separation via rotational effects and gravity.

The desorbed product vapors 718 are transferred to a fractionator 724 as a products feed 722. The desorbed product vapors 718 are separated into cracked hydrocarbon fractions 726 by molecular weight and their boiling points by the fractionator 724. The fractionator 724 is any vessel that is vertically oriented and receives cracking products (i.e., the products feed 722) for recovery after they are separated from the reacted catalyst with adsorbed product vapors 714b by the reactor 716. The fractionator 724 operates in a similar way to the atmospheric distillation column 528 previously described with respect to FIG. 5 to produce streams of cracked hydrocarbon fractions 726. In addition to the streams of cracked hydrocarbon fractions 726, the fractionator 724 separates an offgas 728 and a slurry oil 738. The offgas 728 is cooled by an absorption chiller 730 (to around a temperature of 38° C.). The absorption chiller 730 generates a cooling fluid using the heat transfer fluid 404c and a condenser 732. The offgas 728 is processed by an offgas separator 734 to produce a hydrogen stream 736. The offgas separator 734 may be a pressure swing adsorption (PSA) system used for capture and separation of hydrogen (H₂) from the offgas 728, and/or membrane separation or cryogenic separation methods may be used in addition to or in place of PSA. Temperature swing adsorption (TSA) may also be used along with or in place of PSA to selectively target a specific gas. PSA and TSA operate on the mechanisms of adsorption behaviors that are unique to each specific gas. H₂ possesses different physicochemical properties that permit them to be absorbed and desorbed on adsorbent surfaces under different pressure-temperature conditions. In this way, H₂ can be separated through these adsorption/desorption processes. Example adsorbents include zeolites and activated carbon.

The hydrogen stream 736 may be stored and/or further processed for final production. Conventional refineries may treat H₂ as a waste byproduct by burning the offgas 728 in refinery flares which may contribute to pollution in the local atmosphere. Some refineries may use the offgas 728 as a fuel or a heat source to power refinery operations, which reduces pollution emissions. However, in the improved system 700, the offgas 728 can instead be used to produce additional products to reduce pollution and improve overall operating efficiency through the collection of more useful products.

During FCC, the catalyst 714a and the coked catalyst 740 are exchanged between the reactor 716 and a regenerator 742 as it adsorbs and desorbs coke from catalyst surfaces. Coke is a carbon waste byproduct that renders the catalyst 714a unusable and must be baked off by the regenerator 742. Coke removal during regeneration is an exothermic process, and the catalyst 714a retains some heat as it is returned to the riser 710. Additional heat is supplemented by a steam generator 712 (as described above) heated by a heat transfer fluid 404c heated in the wellbore 302 by magma. This additional heat requirement being met by geothermal sources eliminates the need for using other energy sources and reduces the carbon footprint of the fuel refining process.

During regeneration of the coked catalyst 740 (described further below), air 744a is heated by a heat exchanger 706c, which can be heated by heat transfer fluid 404c, to produce a heated air 744b. The heat exchanger 706c is depicted as disposed in a position to circulate the heated heat transfer fluid to heat the air 744a after being moved by an air blower 746 in FIG. 7, but in other embodiments the heat exchanger 706c can be positioned to heat the air 744a before being moved by the air blower 746. Examples of the heat exchanger 706c include shell-and-tube or tube-in-tube type heat exchangers. The heated air 744b is moved to the regenerator 742. In the example of FIG. 7, a geothermally powered motor 702 coupled to the air blower 746 may power the air blower 746. The geothermally powered motor 702 can be coupled to the air blower 746 using conventional means, e.g., mechanical, electrical, pneumatic, etc., which are omitted for the sake of simplicity. The air blower 746 is any machine capable of moving the heated air 744b to heat a coked catalyst 740 to facilitate regeneration to produce regenerated catalyst 758 (to be used as catalyst 714a ) that can be used in the riser 710 for catalytic cracking. In the example of FIG. 7, the air blower 746 may include direct fired process air heaters, centrifugal air blowers, and/or axial fans as examples. The geothermally powered motor 702 may be powered directly by the heat transfer fluid 404c that is heated by the magma reservoir 214 or using electricity 408.

The coked catalyst 740 may be heated by the heat exchanger 706d that is used to heat the regenerator 742 (e.g., around 590 to 760° C.), which can be heated by heat transfer fluid 404c. This heat exchanger 706d may be used in addition to or in place of the heat exchanger 706c that is used to heat the air 744a. The heat exchanger 706d is depicted as disposed proximal to the regenerator 742 in FIG. 7 to circulate the heated heat transfer fluid to provide heat to the walls of the regenerator 742 to indirectly heat the coked catalyst 740, but in other embodiments the heat exchanger 706d can be positioned within the regenerator 742 which can then directly heat the coked catalyst 740 to produce a regenerated catalyst 758. Heat exchange between the heat exchanger 706d and the regenerator 742 can maintain a predefined temperature range for heating the coked catalyst 740 to form the regenerated catalyst 758. The regenerated catalyst 758 is returned to the riser 710 to be used in the catalytic cracking reactions.

During regeneration, flue gas 750 is produced as a byproduct of converting the coked catalyst 740 to the regenerated catalyst 758. The flue gas 750 is produced during heating coked catalyst and includes hydrocarbons, sulfur oxides, ammonia, aldehydes, nitrogen oxides, cyanides, CO (carbon monoxide), and particulates which must be removed due to their being significant air pollutant contributors. The flue gas 750 is cooled by an absorption chiller 730 (to around a temperature of 38° C.). The absorption chiller 730 generates a cooling fluid by condensing the heat transfer fluid 404c. In the example of FIG. 7, the flue gas 750 is processed by a flue gas separator 752 to produce a CO stream 754 and a CO₂ stream 756 (carbon dioxide). The flue gas separator 752 may be a PSA system used for capture and separation of gases (e.g., CO and CO₂) from the flue gas 750, and/or membrane separation or cryogenic separation methods may be used in addition to or in place of PSA. TSA may also be used along with or in place of PSA to selectively target a specific gas. Example adsorbents used for PSA and TSA include zeolites and activated carbon.

The CO stream 754 and the CO₂ stream 756 may be stored and/or further processed for final production. Example methods of removal include cyclones and/or electrostatic precipitators or wet scrubbers. CO waste heat boilers reduce the CO and hydrocarbon emissions to negligible levels. However, the system 700 of this disclosure uses geothermally heated fluids (heat transfer fluid 404c) to process the CO and CO₂ to produce a range of desirable hydrocarbons rather than treating as a waste by product by reducing it in a CO boiler. Refineries typically waste CO and CO₂ by burning the flue gas 750 in refinery flares as a waste gas which may contribute to pollution in the local atmosphere. System 700 instead uses the flue gas 750 to produce additional products to reduce pollution and to enhance operating efficiency. The CO can be used in Fischer-Tropsch (FT) synthesis of a range of useful hydrocarbons when combined with H₂ recovered in the hydrogen recovery unit. Syngas, olefins, natural gas liquids, diesels, paraffins and more can be produced using FT synthesis. The CO can also be used in meat and fish packaging as a modified atmosphere to increase shelf life and as a therapeutic in the treatment of cancers and cardiovascular diseases. The CO₂ can be used in enhanced oil recovery by injection into oil wells to flush residual oil from a subsurface rock formation between wells.

### Example Method of Geothermally Powered Cracking

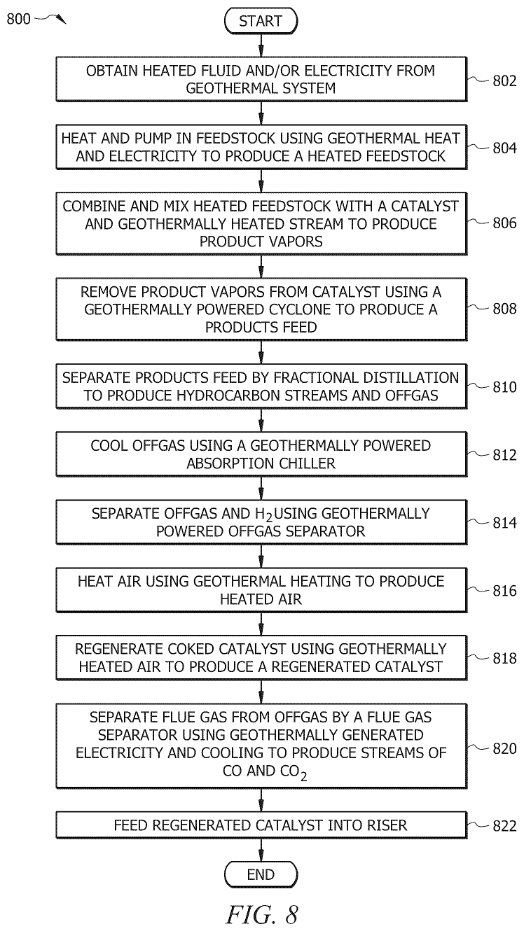

FIG. 8 shows an example method 800 of operating the geothermally powered cracking system 700 in FIG. 7. The method 800 may begin at step 802. At step 802, the heat transfer fluid 404c and/or electricity 408 are received from the geothermal system, as described above with respect to FIGS. 1-4. At step 804, feedstock 704a is pumped using a geothermally powered motor 702 and heated with the heat transfer fluid 404c to produce a heated feedstock 704b. At step 806, a reacted catalyst with adsorbed product vapors 714b are produced by combining and mixing the heated feedstock 704b with a catalyst 714a. At step 808, desorbed product vapors 718 are removed from the reacted catalyst with adsorbed product vapors 714b to produce a products feed 722, by using a cyclone 720 that may be geothermally powered by the heat transfer fluid 404c and/or electricity 408. At step 810, the products feed 722 is separated by fractional distillation to produce cracked hydrocarbons streams and offgas 728. At step 812, gases (i.e., the offgas 728) is cooled by an absorption chiller using a geothermally derived cooling fluid. At step 814, the cooled offgas is separated using an offgas separator 734 to produce a hydrogen stream 736. Step 814 may be driven by using a geothermally powered motor 702. At step 816, air 744a is heated with the heat transfer fluid 404c to produce a heated air 744b. At step 818, a coked catalyst 740 is heated with the heated air 744b and/or the heat transfer fluid 404c to produce a regenerated catalyst 758. At step 820, a flue gas 750 is cooled by using a geothermally derived cooling fluid and gases are separated to produce a CO stream 754 and a CO₂ stream 756. At step 822, the regenerated catalyst 758 is fed to the riser 710 to be used in the catalytic cracking process again.

Modifications, omissions, or additions may be made to method 800 depicted in FIG. 8. Method 800 may include more, fewer, or other steps. For example, at least certain steps may be performed in parallel or in any suitable order. While at times discussed as geothermally powered cracking system 700 performing steps, any suitable component of the geothermally powered cracking system 700 or other components of a geothermal system may perform or may be used to perform one or more steps of the method 800.

### Example Geothermally Powered Reforming

FIG. 9 shows an example of a geothermally powered reforming system 900 that can be used as the system 410 of FIG. 4. The configuration of FIG. 9 is provided as an example only. The geothermally powered reforming system 900 may include more or fewer components, and the components may be arranged in different configurations in order to produce reformate 942. In the example geothermally powered reforming system 900 shown in FIG. 9, a series of three reformers is depicted, but in other embodiments two or less reformers may be used, and likewise, four or more reformers may be used. Furthermore, reforming may be performed in one reformer in an alternating cycle with catalyst regeneration. The example geothermally powered reforming system 900 includes a reactor 910, a regenerator 920, a hydrogen separator 934, and a stabilizer 938. These main components and other components may be powered at least partially by geothermal energy from the heat transfer fluid 404c (e.g., steam). This heat transfer fluid 404c may be used directly to heat components in the geothermally powered reforming system 900 or to heat a secondary heat transfer fluid. The secondary heat transfer fluid may be any similarly suitable fluid as chosen in the primary heat transfer fluid 404c. The heat transfer fluid 404c or secondary heat transfer fluid may be used to heat components or may be converted to mechanical or electrical energy to perform operations in the geothermally powered reforming system 900. The geothermally powered reforming system 900 uses geothermal heating to change the chemical structure of hydrocarbons in a feedstock 906a to produce a reformate 942.

The example geothermally powered reforming system 900 is depicted as a catalytic reforming unit (CRU) which utilizes a continuous flow feedstock with fluidized-bed catalysts in which the catalyst 912 is removed and replaced during the operation, which maintains high activity with little off-stream time. In other embodiments, the geothermally powered reforming system 900 can be a semi-regenerative system in which the unit is taken off-stream anywhere from every 3 to 24 months or a cyclic system which involves swing reactor in which several reactors are operated and when taken off-stream use extra reactors. CRU processes may have reactors in a side-by-side or stacked configuration. The geothermally powered reforming system 900 of FIG. 9 has a side-by-side configuration. However, this disclosure contemplates the geothermally powered reforming system 900 having any reactor configuration.

During operation of the geothermally powered reforming system 900, a feedstock 906a is heated by a heat exchanger 908a, which can be heated by heat transfer fluid 404c, to circulate the heated heat transfer fluid to produce a heated feedstock 906b (e.g., to around 495 to 525° C.). Examples of the heat exchanger 908a include shell-and-tube or tube-in-tube type heat exchangers. An example feedstock 906a may be a naphtha that was produced by the geothermally powered fractional distillation system 500 and/or the geothermally powered cracking system 700. The feedstock 906a may be first treated to remove sulfur and other compounds that would inhibit catalysis. The heated feedstock 906b is moved to the reactor 910 using a geothermally powered pump 904. In the example of FIG. 9, a geothermally powered motor 902 may be coupled to the geothermally powered pump 904 using conventional means, e.g., mechanical, electrical, pneumatic, etc., which are omitted for the sake of simplicity. The geothermally powered pump 904 is any machine capable of moving the feedstock 906a to be heated by the heat exchanger 908a and the heated feedstock 906b to the reactor 910. In the example geothermally powered reforming system 900 shown in FIG. 9, only one geothermally powered pump 904 is depicted, but in other embodiments, two or more geothermally powered pumps may be used. Furthermore, the geothermally powered pump 904 may be positioned at another location, for example, to move the heated feedstock 906b after the heat exchanger 908a has heated the feedstock 906a to the reactor 910. In the example of FIG. 9, the geothermally powered pump 904 may include injectors, nozzles, jets, and/or atomizers, as examples. The geothermally powered motor 902 may be powered directly by the heat transfer fluid 404c that is heated by the magma reservoir 214 or using electricity 408. The geothermally powered motor 902 may be the same type of motor as motor 502 of FIG. 5, described above.

During catalytic reforming, a complex series of reactions occur over the catalyst 912 that change the chemical structure of the hydrocarbons to convert a low-octane stock into a high-octane “reformate” used for gasoline blending stock and high-value aromatics (e.g., benzene, toluene and xylene, BTX) for petrochemical use. An example reaction may be the dehydrogenation of naphthenes to form aromatics. Another example reaction may be the dehydrogenation (i.e., dehydrocyclization) of paraffins to form aromatics, and the isomerization of normal paraffins to isoparaffins. The catalyst 912 is fed to the reactor 910 where it reacts with the heated feedstock 906b. The reactor 910 is any vessel that combines the catalyst 912, and the heated feedstock 906b to facilitate catalytic reforming to change the chemical structure of the hydrocarbons. The catalyst 912 is heated and mixed to form a fluidized bed of hot catalyst particles and is brought into contact with the heated feedstock 704b. The catalyst 912 evaporates the heated feedstock 906b upon contact in the reactor 910, and the reforming reactions initiate on the active sites of the surfaces of the catalyst 912. An example catalyst 912 may include platinum and/or rhenium. The catalyst 912 may be a fine powder with an average particle size of 60-75 μm. An example reaction occurring in the reactor 910 involving the dehydrogenation of the naphthene methylcyclohexane to the aromatic toluene might be: CH₃C₆H₁₁→CH₃C₆H₅+3H₂. The reactions occur over a noble metal catalyst, such as platinum or rhenium. The reforming reactions are endothermic, so heat must be continually supplied to the system to maintain reaction temperatures. Therefore, reforming reactions are performed in a series of reactors where heat is transferred to the heated feedstock 906a through heat exchangers placed in between each reactor 910.

Reforming reactions produce product vapors 914 on the surfaces of the catalyst 912 and are then separated by the reactor 910. The reactor 910 is a vessel that produces the product vapors 914 by using the catalyst 912 to cause the heated feedstock 906b to react to form different chemical structures of hydrocarbons and separates them to produce a heated products feed 928a. Reforming reactions may also deposit a significant amount of coke on the catalyst 912, leading to deactivation of the catalyst 912 and formation of coked catalyst 918. The adsorbed hydrocarbons are removed by steam stripping and use of a cyclone 916. The coked catalyst 918 is then sent to a regenerator 920 to remove (e.g., burn off) the coke with air 924a, which, may be geothermally heated as described in below. The cyclone 916 is used by the reactor 910 to separate the catalyst 912 particles from the reacting product vapors 914. Separation may be performed through vortex separation via rotational effects and gravity. The cyclone 916 in the reactor 910 is powered by heat transfer fluid 404c and/or electricity 408 generated by geothermal turbines (e.g., the first turbine set 1104, the second turbine set 1108 of FIG. 11) configured to use the heat transfer fluid 404c heated by the geothermal system 300.

Once a desired chemical constitution is satisfied, hydrogen stream 936 is separated from the heated products feed 928a. The heated products feed 928a is cooled by an absorption chiller 930 (to around a temperature of 38° C.) to produce a cooled products feed 928b. The absorption chiller 930 generates a cooling fluid using the heat transfer fluid 404c and a condenser 932. The cooled products feed 928b is processed by a hydrogen separator 934 to separate gases (i.e., produce a hydrogen stream 936). The hydrogen separator 934 may be a pressure swing adsorption (PSA) system used for capture and separation of H₂ from the cooled products feed 928b, and/or membrane separation or cryogenic separation methods may be used in addition to or in place of PSA. Temperature swing adsorption (TSA) may also be used along with or in place of PSA to selectively target a specific gas. PSA and TSA operate on the mechanisms of adsorption behaviors that are unique to each specific gas. H₂ possesses different physicochemical properties that permit them to be absorbed and desorbed on adsorbent surfaces under different pressure-temperature conditions. In this way, H₂ can be separated through these adsorption/desorption processes. Example adsorbents include zeolites and activated carbon.

The hydrogen stream 936 may be stored and/or further processed for final production. Refineries may burn off the hydrogen stream 936 in refinery flares as a waste gas which may contribute to pollution in the local atmosphere. Some refineries may use the hydrogen from the hydrogen stream 936 as a fuel or a heat source to power refinery operations, which reduces pollution emissions. However, in the improved system 900, the hydrogen stream 936 can instead be used to produce additional products to reduce pollution and improve overall operating efficiency through the collection of more useful products. Hydrogen production is desired because it provides the atmosphere necessary for the reforming reactions and reduces coke formation on the catalyst 912, thus extending its operating life between regeneration. An excess of hydrogen above whatever is consumed in the process is produced and may be transferred to useful valuable products downstream.

The cooled products feed 928b, once hydrogen separation is complete, is processed by the stabilizer 938. The cooled products feed 928b is reheated by a heat exchanger 908c, which can be heated by heat transfer fluid 404c, to circulate the heated heat transfer fluid to produce a reheated products feed 928c to a predefined temperature range (e.g., to around 495 to 525° C.). Examples of the heat exchanger 908c include shell-and-tube or tube-in-tube type heat exchangers. The reheated products feed 928c is fed to the stabilizer 938 is where it is fractionally distilled (i.e., separated into fractions of hydrocarbons by their molecular weight). Pressure may be maintained near atmospheric pressure (e.g., 1.2 to 1.5 atm) within the stabilizer 938. The stabilizer 938 may be any vessel that facilitates separation of light hydrocarbons 940 and reformate 942 from the reheated products feed 928c. Higher molecular weight hydrocarbons have higher boiling points and are separated at the hotter bottom side of the stabilizer 938. Lighter molecular weight hydrocarbons have lower boiling points and move upwards as vaporized light hydrocarbons 940. The stabilizer 938 operates in a similar way to the atmospheric distillation column 528 previously described with respect to FIG. 5 to produce streams of the light hydrocarbons 940 and the reformate 942. The reformate 942 may be further processed to separate the hydrocarbon fractions by molecular weight. A portion of the reformate 942 may be sent to the fractionator 724 described in FIG. 7 above.

As reforming reactions progress, coke may accumulate on the catalyst 912, reducing the reactivity of the particles of catalyst 912 and causing the formation of the coked catalyst 918. The coked catalyst 918 must be occasionally regenerated by the regenerator 920. The coke is removed (e.g., burned off) from the particle surfaces of the coked catalyst 918 with heated air 924a which may be heated by geothermally heated steam heated by the magma to strip coke from the coked catalyst 918 to produce a regenerated catalyst 926. The regenerated catalyst 926 is fed to the reactor 910 to continue the cyclic process of catalytic reforming, coke formation, coke removal, and catalyst regeneration.

During reforming, the catalyst 912 is exchanged between the reactor 910 and the regenerator 920 as it adsorbs and desorbs coke. Coke removal during regeneration is an exothermic process, and the catalyst 912 retains some heat as it is returned to the reactor 910. Additional heat is supplemented by the heat from the heated feedstock 906b heated by the heat exchanger 908a which may be heated by steam received from a heat transfer fluid 404c heated in the wellbore 302 by magma. This additional heat requirement being met by geothermal sources eliminates the need for using other energy sources and reduces the carbon footprint of the fuel refining process. During regeneration of the coked catalyst 918, air 924a is heated by a heat exchanger 908b, which can be heated by heat transfer fluid 404c, to produce a heated air 924b (e.g., to around 590 to 760° C.). The heat exchanger 908b is depicted as disposed in a position to circulate the heated heat transfer fluid to heat the air 924a after being moved by an air blower 922 in FIG. 9, but in other embodiments the heat exchanger 908b can be positioned to heat the air 924a before being moved by the air blower 922. Examples of the heat exchanger 908b include shell-and-tube or tube-in-tube type heat exchangers. The heated air 924b is moved to the regenerator 920. In the example of FIG. 9, a geothermally powered motor 902 coupled to the air blower 922 may power the air blower 922. The geothermally powered motor 902 can be coupled to the air blower 922 using conventional means, e.g., mechanical, electrical, pneumatic, etc., which are omitted for the sake of simplicity. The air blower 922 is any machine capable of moving the heated air 924b to heat a coked catalyst 918 to facilitate regeneration to produce the regenerated catalyst 926 that can be used in the reactor 910 for catalytic reforming. In the example of FIG. 9, the air blower 922 may include direct fired process air heaters, centrifugal air blowers, and/or axial fans as examples. The geothermally powered motor 902 may be powered directly by the heat transfer fluid 404c that is heated by the magma reservoir 214 or using electricity 408. During regeneration, flue gas may be produced as a byproduct of converting the coked catalyst 918 to the regenerated catalyst 926 and may processed in the same way as described in FIG. 7 above to produce streams of CO and CO₂ which may be stored and/or further processed for final production.

### Example Method of Geothermally Powered Reforming

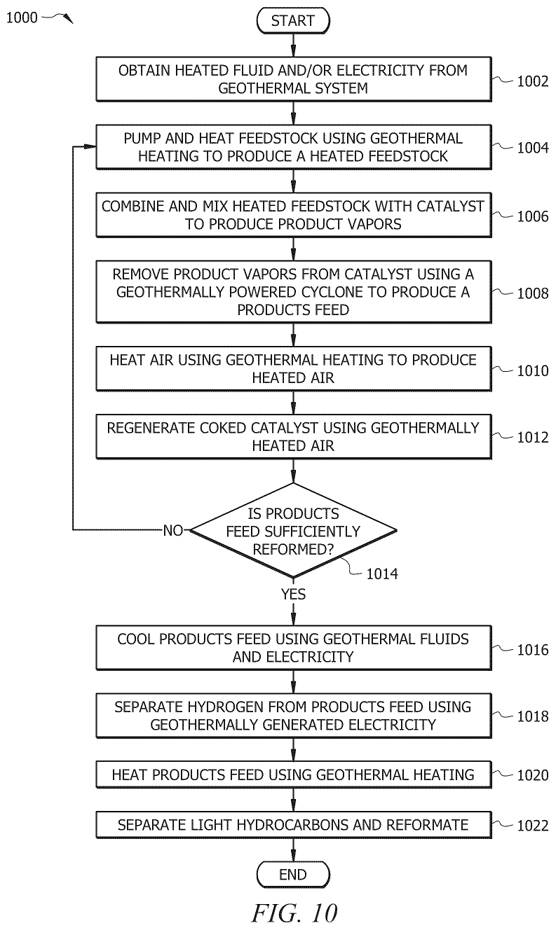

FIG. 10 shows an example method 1000 of operating the geothermally powered reforming system 900 in FIG. 9. The method 1000 may begin at step 1002. At step 1002, the heat transfer fluid 404c and/or electricity 408 are received from the geothermal system, as described above with respect to FIGS. 1-4. At step 1004, feedstock 906a is pumped using a geothermally powered motor 902 and heated with the heat transfer fluid 404c to produce a heated feedstock 906b. At step 1006, product vapors 914 are produced by combining and mixing the heated feedstock 906b with a catalyst 912. At step 1008, the product vapors 914 are removed from the catalyst 912 to produce a heated products feed 928a, by using a cyclone 916 that may be geothermally powered by the heat transfer fluid 404c and/or electricity 408. At step 1010, air is heated and blown into a regenerator using turbines powered by the heat transfer fluid 404c and/or electricity 408 that are received from the geothermal system. At step 1012, a coked catalyst 918 is regenerated for reuse by heating using the heat transfer fluid 404c. At step 1014, the heated products feed 928a is assessed for reformate production. In the example provided in FIG. 9, a series of three consecutive reactors is shown and steps 1002 through 1012 are repeated twice. In other embodiments, different configurations of the reactors and regenerators may be used, and the heated products feed 928a is handled accordingly. If the heated products feed 928a is determined to be sufficiently reformed according to the geothermally powered reforming system 900, operation proceeds to step 1016. At step 1016, the heated products feed 928a is cooled by using a geothermally derived cooling fluid and gases are separated to produce a hydrogen stream 936 and a cooled products feed 928b. Step 1018 may be driven by using a geothermally powered motor 902. At step 1020, the cooled products feed 928b is reheated using the heat transfer fluid 404c to produce a reheated products feed 928c. At step 1022, the reheated products feed 928c is separated into light hydrocarbons 940 and reformate 942.

Modifications, omissions, or additions may be made to method 1000 depicted in FIG. 10. Method 1000 may include more, fewer, or other steps. For example, at least certain steps may be performed in parallel or in any suitable order. While at times discussed as geothermally powered reforming system 900 performing steps, any suitable component of the geothermally powered reforming system 900 or other components of a geothermal system may perform or may be used to perform one or more steps of the method 1000.

### Example Thermal Process System

FIG. 11 shows a schematic diagram of an example thermal process system 304 of FIGS. 3 and 4. The thermal process system 304 includes a condenser 1102, a first turbine set 1104, a second turbine set 1108, a high-temperature/pressure thermochemical process 1112, a medium-temperature/pressure thermochemical process 1114, and one or more lower temperature/pressure processes 1116a,b. The thermal process system 304 may include more or fewer components than are shown in the example of FIG. 11. For example, a thermal process system 304 used for power generation alone may omit the high-temperature/pressure thermochemical process 1112, medium-temperature/pressure thermochemical process 1114, and lower temperature/pressure processes 1116a,b. Similarly, a thermal process system 304 that is not used for power generation may omit the first turbine set 1104 and the second turbine set 1108. As a further example, if heat transfer fluid is known to be received only in the gas phase, the condenser 1102 may be omitted in some cases. The ability to tune the properties of the heat transfer fluid received from the unique wellbore 302 of FIGS. 3 and 4 facilitates improved and more flexible operation of the thermal process system 304. For example, the depth of the wellbore 302, the residence time of heat transfer fluid in the magma reservoir 214, the pressure achieved in the wellbore 302, and the like can be selected or adjusted to provide desired heat transfer fluid properties at the thermal process system 304.

In the example of FIG. 11, the condenser 1102 is connected to the wellbore 302 that extends between a surface and the underground magma reservoir. The condenser 1102 separates a gas-phase heat transfer fluid (e.g., steam) from liquid-phase heat transfer fluid (e.g., condensate formed from the gas-phase heat transfer fluid). The condenser 1102 may be a steam separator. A stream 1120 received from the wellbore 302 may be provided to the condenser 1102. In some cases, all of stream 1118 is provided in stream 1120. In other cases, a fraction or none of stream 1118 is provided to the condenser 1102. Instead, all or a portion of the stream 1118 may be provided as stream 1128 which may be provided to the first turbine set 1104 and/or to a high-temperature/pressure thermochemical process 1112 in stream 1129. The high-temperature/pressure thermochemical process 1112 may be a thermochemical reaction requiring high temperatures and/or pressures (e.g., temperatures of between 500 and 2,000° F. and/or pressures of between 1,000 and 4,500 psig), such as the geothermally powered fractional distillation system 500. One or more valves (not shown for conciseness) may be used to control the direction of stream 1120 to the condenser 1102, first turbine set 1104, and/or high-temperature/pressure thermochemical process 1112. A gas-phase stream 1122 of heat transfer fluid from the condenser may be sent to the first turbine set 1104 and/or the high-temperature/pressure thermochemical process 1112 via stream 1126. A liquid-phase stream 1124 of heat transfer fluid from the condenser 1102 may be provided back to the wellbore 302.

The first turbine set 1104 includes one or more turbines 1106a,b. In the example of FIG. 11, the first turbine set 1104 includes two turbines 1106a,b. However, the first turbine set 1104 can include any appropriate number of turbines for a given need. The turbines 1106a,b may be any known or yet to be developed turbine for electricity generation. The first turbine set 1104 is connected to the condenser 1102 and is configured to generate electricity from the gas-phase heat transfer fluid (e.g., steam) received from the condenser 1102 (gas-phase stream 1122). A condensate stream 1130 exits the first turbine set 1104. The condensate stream 1130 may be provided back to the wellbore 302.

If the heat transfer fluid is at a sufficiently high temperature, as may be uniquely and more efficiently possible using the wellbore 302, a stream 1132 of gas-phase heat transfer fluid may exit the first turbine set 1104. Stream 1132 may be provided to a second turbine set 1108 to generate additional electricity. The turbines 1110a,b of the second turbine set 1108 may be the same as or similar to turbines 1106a,b, described above.

All or a portion of stream 1132 may be sent as gas-phase stream 1134 to a medium-temperature/pressure thermochemical process 1114. Medium-temperature/pressure thermochemical process 1114 is generally a process requiring gas-phase heat transfer fluid at or near the conditions of the heat transfer fluid exiting the first turbine set 1104. For example, the medium-temperature/pressure thermochemical process 1114 may include one or more thermochemical processes requiring steam or another heat transfer fluid at or near the temperature and pressure of stream 1132 (e.g., temperatures of between 250 and 1,500° F. and/or pressures of between 500 and 2,000 psig). The second turbine set 1108 may be referred to as “low pressure turbines” because they operate at a lower pressure than the first turbine set 1104. Condensate from the second turbine set 1108 is provided back to the wellbore 302 via stream 1136.

An effluent stream 1138 from the second turbine set 1108 may be provided to one or more thermal process 1116a,b. Thermal processes 1116a,b generally require less thermal energy than high-temperature/pressure thermochemical process 1112 and medium-temperature/pressure thermochemical process 1114, described above (e.g., processes 1116a,b may be performed temperatures of between 220 and 700° F. and/or pressures of between 15 and 120 psig). As an example, processes 1116a,b may include water distillation processes, heat-driven chilling processes, space heating processes, agriculture processes, aquaculture processes, and/or the like. For instance, an example heat-driven chiller process 1116a may be implemented using one or more heat driven chillers. Heat driven chillers can be implemented, for example, in data centers, crypto-currency mining facilities, or other locations in which undesirable amounts of heat are generated. Heat driven chillers, also conventionally referred to as absorption cooling systems, use heat to create chilled water. Heat driven chillers can be designed as direct-fired, indirect-fired, and heat-recovery units. When the effluent includes low pressure steam, indirect-fired units may be preferred. An effluent stream 1140 from all processes 1112, 1114, 1116a,b, may be provided back to the wellbore 302.

### Example Temperature Control System

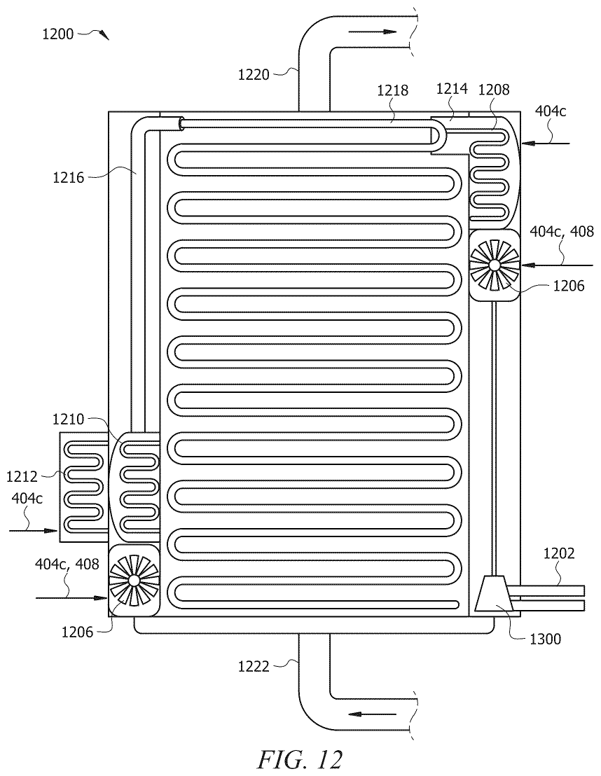

FIG. 12 shows an example temperature control system 1200 of FIG. 5. The temperature control system 1200 includes temperature sensors 1202, a temperature controller 1300, geothermally powered motors 1206, a heat exchanger 1208, one or more circulating coolers 1210, an absorption chiller 1212, and a thermal fluid system 1218. The temperature control system 1200 may include more or fewer components than are shown in the example of FIG. 12. For example, a temperature control system 1200 used for heating alone may omit the circulating coolers 1210 and the absorption chiller 1212. Similarly, a temperature control system 1200 that is used for cooling alone may omit the heat exchanger 1208. The ability to independently adjust the functions of heating and cooling by use of the temperature control system 1200 facilitates improved and more flexible response to fluctuating temperatures measured in system components. For example, a smelting process may necessitate a vessel to be maintained within an operational temperature range (i.e., a minimum temperature to drive an electrochemical reaction and a maximum temperature to curtail formation of byproducts). The temperature setpoint for such a vessel can be selected or adjusted to provide desired optimal temperatures.

In the example of FIG. 12, the temperature of a system component (e.g., an electrolytic smelter) is measured by the temperature sensors 1202. Example temperature sensors are thermostats, thermistors, resistive temperature detectors, thermocouples, and semiconductor-based sensors. If the temperature measurement exceeds a heating setpoint, the temperature controller 1300 (see FIG. 13 and corresponding descriptions below) switches the heat exchanger 1208 off. As an example, a pump relay switch may be used in conjunction with the fluid pumps 1314 to control flow of heat transfer fluid from the heat exchanger 1208 through a heated fluid input 1214 or the circulating coolers 1210 and the absorption chiller 1212 through a cooled fluid input 1216 to heat or cool the thermal fluid system 1218, respectively. If the temperature measurement exceeds a maximum threshold, the heat exchanger 1208 is shut off and the temperature controller 1300 switches the circulating coolers 1210 on to begin cooling the thermal fluid system 1218. If the temperature measurement exceeds a cooling setpoint, the temperature controller 1300 switches the circulating coolers 1210 off. If the temperature measurement exceeds a minimum threshold, the circulating coolers 1210 is shut off and the heat exchanger 1208 is turned on to begin heating the thermal fluid system 1218. The heat transfer fluid of the thermal fluid system 1218 is fed to the system component in need of heating or cooling via a thermal fluid output 1220 and is returned to the thermal fluid system 1218 via a thermal fluid input 1222.

The temperature control system 1200 can deliver high temperature thermal fluid via heat transfer fluids in contact with a magma chamber or in contact with heat transfer fluids heated by a magma chamber for operations that require heating. Heated heat transfer fluids can heat the thermal fluid in the thermal fluid system 1218 via heat exchange with the heat exchanger 1208. This ability to obtain high heat transfer allows deployment of alternative methods of heating during smelting and converting compared to conventional fossil fuels. Geothermal heating can extract copper from lower grade ores using less energy consumption and producing lower CO₂ emissions, resulting in reduced economic loss and environmental impacts.

The temperature control system 1200 can deliver low temperature thermal fluid via heat transfer fluids routed by a circulating coolers 1210 and cooled by an absorption chiller 1212 for operations that require cooling. Cooled heat transfer fluids can cool the thermal fluid in the thermal fluid system 1218 via heat exchange with the circulating coolers 1210. This ability to expedite the cooling process compared to passive cooling (i.e., allowing the system component to cool via turning off heating and waiting) can reduce waste generated as byproducts and hasten cooling to more quickly produce finished copper products leading to economic gains.

FIG. 11 illustrates an example temperature controller 1300 in greater detail. The example temperature controller 1300 includes a processor 1302, interface 1304, and memory 1306. The processor 1302 is electronic circuitry that coordinates operations of the temperature controller 1300. The processor 1302 may be a programmable logic device, a microcontroller, a microprocessor, or any suitable combination of these or similar components. The processor 1302 is communicatively coupled to the memory 1306 and interface 1304. The processor 1302 may be one or more processors. The processor 1302 may be implemented using hardware and/or software.

The interface 1304 enables wired and/or wireless communications of data or other signals between the temperature controller 1300 and other devices, systems, or domain(s), such as the temperature sensors 1202 and other temperature control equipment 1312. The temperature control equipment 1312 may correspond to any components of the temperature control system illustrated in FIG. 13 or otherwise understood by a skilled person to be employed in petrochemical processing operations. For example, the temperature control equipment 1312 may include one or more geothermally powered motors 1206 (e.g., to power fluid pumps 1314), fluid pumps 1314, and a display 1316 (e.g., an electronic display capable of displaying information determined by the temperature controller 1300). The interface 1304 is an electronic circuit that is configured to enable communications between these devices. For example, the interface 1304 may include one or more serial ports (e.g., USB ports or the like) and/or parallel ports (e.g., any type of multi-pin port) for facilitating this communication. As a further example, the interface 1304 may include a network interface such as a WIFI interface, a local area network (LAN) interface, a wide area network (WAN) interface, a modem, a switch, or a router. The processor 1302 may send and receive data using the interface 1304. For instance, the interface 1304 may send instructions to turn on the heat exchanger 1208 when a temperature measurement of a system component below the heating setpoint is detected. The interface 1304 may provide signals to cause a display 1316 to show an indication that a heating mode is being automatically implemented or should be implemented by an operator of a system component associated with the temperature controller 1300.

The memory 1306 stores any data, instructions, logic, rules, or code to execute the functions of the temperature controller 1300. For example, the memory 1306 may store temperatures 1308, such as the temperature measured inside a desalter 508, and comparing to the setpoints 1310 to determine necessary operations. The memory 1306 may also store temperatures 1308 and setpoints 1310. As described in more detail with respect to the various examples above, the temperatures 1308 may be used to detect when the temperature of a system component has reached one of the setpoints 1310. For instance, if the temperatures 1308 is detected by the temperature sensors 1202 as exceeding the range of the temperature in the setpoints 1310, the relay 1318 may be used to operate the heat exchanger 1208 or the circulating coolers 1210. The memory 1306 may include one or more disks, tape drives, solid-state drives, and/or the like. The memory 1306 may store programs, instructions, and data that are read during program execution. The memory 1306 may be volatile or non-volatile and may comprise read-only memory (ROM), random-access memory (RAM), ternary content-addressable memory (TCAM), dynamic random-access memory (DRAM), and static random-access memory (SRAM).

### Example Method of Operating Temperature Control System

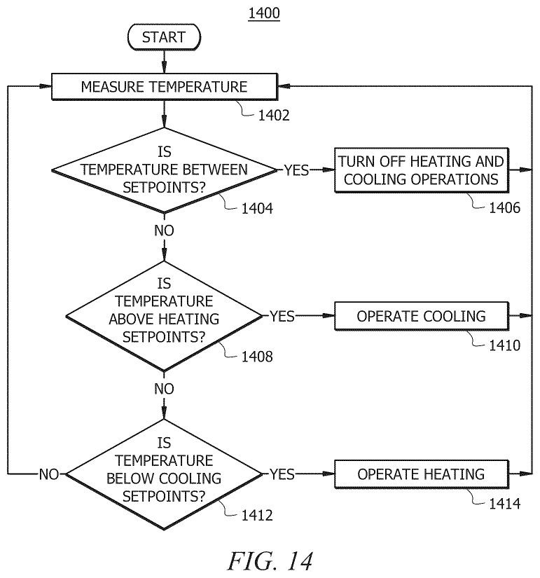

FIG. 14 illustrates an example method 1400 of operation of the temperature control system 1200. The method 1400 may begin at step 1402 where the temperature of a system component can be measured by use of the temperature sensors 1202. At step 1404, the temperature measured at step 1402 is stored as temperatures 1308 and compared to the setpoints 1310, as described above with respect to the example of FIG. 13. If the temperatures 1308 are determined to be within the range of temperatures in the setpoints 1310 (e.g., a cooling setpoint and a heating setpoint), operation proceeds to step 1406. At step 1406, all heating and cooling operations are turned off by using the relay 1318, then operations proceed to repeat step 1402 to measure the temperature of the system component by use of the temperature sensors 1202.

At step 1404, if the temperatures 1308 are determined to be outside the range of temperatures in the setpoints 1310, operation proceeds to step 1408. If the temperatures 1308 are determined to be exceeding the setpoints 1310 for heating, operation proceeds to step 1410. At step 1410, cooling operations (i.e., the circulating coolers 1210 and the absorption chiller 1212) are turned on by using the relay 1318 or remain on, then operations proceed to repeat step 1402 to measure the temperature of the system component by use of the temperature sensors 1202.

At step 1408, if the temperatures 1308 are determined to not be exceeding the setpoints 1310 for heating, operation proceeds to step 1412. If the temperatures 1308 are determined to exceed the setpoints 1310 for cooling, operation proceeds to step 1414. At step 1414, cooling operations are turned off if they are on by the use of the relay 1318 and heating operations (i.e., the heat exchanger 1208) are turned on or remain on, then operations proceed to repeat step 1402 to measure the temperature of the system component by use of the temperature sensors 1202. If the temperatures 1308 are determined to be not exceeding the setpoints 1310 for cooling, operation returns to step 1402 to repeat temperature measurement.

Modifications, omissions, or additions may be made to method 1400 depicted in FIG. 14. Method 1400 may include more, fewer, or other steps. For example, at least certain steps may be performed in parallel or in any suitable order. All or a portion of the operations may be performed by or facilitated using information determined using the temperature control system of FIG. 13. Any suitable temperature control equipment 1312 or associated component(s) may perform or may be used to perform one or more steps of the method 1400.

While the example systems of this disclosure are described as employing heating through thermal contact with a magma reservoir 214, it should be understood that this disclosure also encompasses similar systems in which another thermal reservoir or heat source is harnessed. For example, heat transfer fluid may be heated by underground water at an elevated temperature. As another example, heat transfer fluid may be heated by radioactive material emitting thermal energy underground or at or near the surface. As yet another example, heat transfer fluid may be heated by lava, for example, in a lava lake or other formation. As such, the magma reservoir 214 may be any thermal reservoir or heat source that is capable of heating heat transfer fluid to achieve desired properties (e.g., of temperature and pressure). Furthermore, the thermal reservoir or heat source may be naturally occurring or artificially created (e.g., by introducing heat underground that can be harnessed at a later time for energy generation or other thermal processes).

The geothermally powered systems of this disclosure may reduce waste in several ways. In addition to the advantages of the alternative equipment and/or methods described above, waste may further be reduced by the ability to process waste byproducts of the geothermally powered petrochemical refining system 410 into useful secondary raw materials. Waste byproducts of petroleum refining often sit idle and contribute to pollution of local environments. The disposal of these byproducts, such as burning off gas in a flare, is wasteful and inefficient. The efficient and clean supply of energy from geothermal resources can power the processing of such wastes. Additionally, waste can be reduced by reducing carbon emissions from the electrostatic coalescence process during desalting. This process requires large amounts of electrical power. An estimated energy requirement of 12000 to 35000 volts to maintain desalting efficiency of 90 to 95% presents challenges to the industry in terms of energy availability and cost and provides profit and environmental motivation to utilizing geothermal energy as presented in this disclosure. As described in this disclosure, geothermal energy can power petroleum refining systems to produce less waste and less pollution (e.g., without using coal-fired processes or with a significant decrease in the use of such processes). As such, this disclosure may facilitate petroleum refining with a decreased environmental impact and decreased use of costly materials and limited resources.

Although embodiments of the disclosure have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments. Moreover, items shown or discussed as coupled or directly coupled or communicating with each other may be indirectly coupled or communicating through some interface device, or intermediate component whether electrically, mechanically, fluidically, or otherwise.

While this disclosure has been particularly shown and described with reference to preferred or example embodiments, it will be understood by those skilled in the art that various changes in form and detail may be made therein without departing from the spirit and scope of the disclosure. Accordingly, this disclosure includes all modifications and equivalents of the subject matter recited in the claims appended hereto as permitted by applicable law. Changes, substitutions and alterations are ascertainable by one skilled in the art and could be made without departing from the spirit and scope disclosed herein. Moreover, any combination of the above-described elements in all possible variations thereof is encompassed by the disclosure unless otherwise indicated herein or otherwise clearly contradicted by context.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

While this disclosure has been particularly shown and described with reference to preferred or example embodiments, it will be understood by those skilled in the art that various changes in form and detail may be made therein without departing from the spirit and scope of the disclosure. Accordingly, this disclosure includes all modifications and equivalents of the subject matter recited in the claims appended hereto as permitted by applicable law. Changes, substitutions and alterations are ascertainable by one skilled in the art and could be made without departing from the spirit and scope disclosed herein. Moreover, any combination of the above-described elements in all possible variations thereof is encompassed by the disclosure unless otherwise indicated herein or otherwise clearly contradicted by context.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

What is claimed is:

1. A system, comprising:
a geothermal system comprising a wellbore extending from a surface into an underground magma reservoir, the wellbore configured to heat a heat transfer fluid via heat transfer with the underground magma reservoir, thereby forming heated heat transfer fluid;
a heat exchanger configured to heat a crude oil feedstock via heat transfer with the heated heat transfer fluid, thereby producing a heated crude oil feedstock; and
a reactor comprising a vessel configured to:
receive at least a portion of the heated crude oil feedstock;
receive a catalyst;
heat the received crude oil feedstock in the presence of the catalyst via heat transfer with the heated heat transfer fluid, thereby causing product vapors to form; and
separate the catalyst and the product vapors to obtain a products feed.

2. The system of claim 1, wherein the reactor is further configured to separate the catalyst and the product vapors by agitating, using a cyclone powered by the heated heat transfer fluid, thereby causing the product vapors to separate from the catalyst to obtain the products feed.

3. The system of claim 1, further comprising a separator configured to:
receive at least a portion of the products feed produced by the reactor;
cool, using one or more circulating coolers, the received products feed via heat transfer with a cooling fluid, thereby producing a cooled products feed, wherein the cooling fluid is generated by a geothermally powered absorption chiller; and
separate hydrogen from the cooled products feed to obtain a hydrogen stream.

4. The system of claim 3, further comprising a stabilizer configured to:
receive at least a portion of the cooled products feed after the hydrogen is separated from the cooled products feed by the separator;
heat the cooled products feed within a predefined temperature range via heat transfer with the heated heat transfer fluid, thereby causing reformate to form; and
separate light hydrocarbons from the reformate.

5. The system of claim 1, further comprising a regenerator configured to:
receive a coked catalyst produced by the reactor;
heat air via heat transfer with the heated heat transfer fluid, thereby causing heated air to form; and
heat the coked catalyst using the heated air, thereby removing coke from the coked catalyst and forming regenerated catalyst.

6. The system of claim 1, further comprising one or more heat exchangers configured to circulate the heated heat transfer fluid to perform one or more of:
heating the crude oil feedstock;
heating the reactor;
heating a stabilizer;
heating a regenerator; and
heating air to produce heated air for the regenerator.

7. The system of claim 5, further comprising one or more turbines configured to use the heated heat transfer fluid to power an air blower configured to move the heated air into the regenerator.

8. A system, comprising:
a heat exchanger configured to heat a crude oil feedstock via heat transfer with a heated heat transfer fluid, wherein the heated heat transfer fluid is obtained from a wellbore extending into an underground magma reservoir, thereby producing a heated crude oil feedstock; and
a reactor comprising a vessel configured to:
receive at least a portion of the heated crude oil feedstock;
receive a catalyst;
heat the received crude oil feedstock in the presence of the catalyst via heat transfer with the heated heat transfer fluid, thereby causing product vapors to form; and
separating the catalyst and the product vapors, to obtain a products feed.

9. The system of claim 8, wherein the reactor is further configured to separate the catalyst and the product vapors by agitating, using a cyclone powered by the heated heat transfer fluid, thereby causing the product vapors to separate from the catalyst to obtain the products feed.

10. The system of claim 8, further comprising a separator configured to:
receive at least a portion of the products feed produced by the reactor;
cool, using one or more circulating coolers, the received products feed via heat transfer with a cooling fluid, thereby producing a cooled products feed, wherein the one or more circulating coolers receive the cooling fluid from an absorption chiller; and
separate hydrogen from the cooled products feed to obtain a hydrogen stream.

11. The system of claim 10, further comprising a stabilizer configured to:
receive at least a portion of the cooled products feed after the hydrogen is separated from the cooled products feed by the separator;
heat the cooled products feed within a predefined temperature range via heat transfer with the heated heat transfer fluid, thereby causing reformate to form; and
separate light hydrocarbons from the reformate.

12. The system of claim 8, further comprising a regenerator configured to:
receive a coked catalyst produced by the reactor;
heat air via heat transfer with the heated heat transfer fluid, thereby causing heated air to form; and
heat the coked catalyst using the heated air, thereby removing coke from the coked catalyst and forming regenerated catalyst.

13. The system of claim 8, further comprising one or more heat exchangers configured to circulate the heated heat transfer fluid to perform one or more of:
heating the crude oil feedstock;
heating the reactor;
heating a stabilizer;
heating a regenerator; and
heating air to produce heated air for the regenerator.

14. The system of claim 12, further comprising one or more turbines configured to use the heated heat transfer fluid to power an air blower configured to move the heated air into the regenerator.

15. A method, comprising:
heating, using a geothermal system comprising a wellbore extending from a surface into an underground magma reservoir, a heat transfer fluid via heat transfer with the underground magma reservoir, thereby forming heated heat transfer fluid;
heating, by a heat exchanger, a crude oil feedstock via heat transfer with the heated heat transfer fluid, thereby producing a heated crude oil feedstock;
receiving, by a reactor, at least a portion of the heated crude oil feedstock;
receiving, by the reactor, a catalyst;
heating the received crude oil feedstock in the presence of the catalyst via heat transfer with the heated heat transfer fluid, thereby causing product vapors to form; and
separating the catalyst and the product vapors to obtain a products feed.

16. The method of claim 15, further comprising obtaining a products feed by agitating, using a cyclone powered by the heated heat transfer fluid, the catalyst and the product vapors, thereby separating the catalyst from the product vapors.

17. The method of claim 15, further comprising producing a hydrogen stream by:
receiving, by a separator, at least a portion of the products feed produced by the reactor;
cooling, using one or more circulating coolers, the received products feed via heat transfer with a cooling fluid, thereby producing a cooled products feed, wherein the cooling fluid is generated by a geothermally powered absorption chiller; and
separating hydrogen from the cooled products feed.

18. The method of claim 17, further comprising producing light hydrocarbons by:
receiving, by a stabilizer, at least a portion of the cooled products feed after the hydrogen is separated from the cooled products feed by the separator;
heating, via heat transfer with the heated heat transfer fluid, the cooled products feed within a predefined temperature range thereby causing reformate to form; and
separating the light hydrocarbons from the reformate.

19. The method of claim 15, further comprising producing a regenerated catalyst by:
receiving, by a regenerator, a coked catalyst produced by the reactor;
heating, via heat transfer with the heated heat transfer fluid, air, thereby causing heated air to form; and
heating, using the heated air, the coked catalyst, thereby removing coke from the coked catalyst and forming the regenerated catalyst.

20. The method of claim 15, further comprising causing one or more heat exchangers positioned to:
heat the crude oil feedstock;
heat the reactor;
heat a stabilizer;
heat a regenerator; and
heat air to produce heated air for the regenerator.
